(19) United States
(12) Patent Application Publication
(10) Pub. No.: US 2025/0389962 A1
(43) Pub. Date: Dec. 25, 2025

(54) OPTICAL SYSTEM AND DISPLAY APPARATUS

(71) Applicant: CANON KABUSHIKI KAISHA, Tokyo (JP)

(72) Inventor: Mikio KOBAYASHI, Tochigi (JP)

(21) Appl. No.: 19/240,562

(22) Filed: Jun. 17, 2025

(30) Foreign Application Priority Data
Jun. 24, 2024 (JP) 2024-101238

(51) Int. Cl. G02B 27/01; G02B 5/18

(52) U.S. Cl. CPC G02B 27/0172; G02B 5/1866

(57) ABSTRACT

An optical system includes a first lens, a second lens disposed on a display surface side relative to the first lens, and a third lens with positive refractive power disposed on the observation side relative to the first lens or on the display surface side relative to the second lens. A surface of the first lens on the display surface side includes a first diffraction surface. A surface of the second lens on the observation side includes a second diffraction surface. The first diffraction surface and the second diffraction surface are adjacent to each other. The optical system further includes a first transmissive reflective surface and a second transmissive reflective surface disposed at positions different from the surface of the first lens disposed on the display surface side of the first lens and the surface of the second lens disposed on the observation side of the second lens.

### BACKGROUND

### Field of the Technology

The present disclosure relates to an optical system for a head-mounted display (HMD) or the like configured to guide light from a display surface to an observation (surface) side to enable an observer (viewer) to observe (view) an image.

### Description of the Related Art

As such an optical system, a so-called folded optical system has been proposed. Japanese Patent No. 7103566 discloses a folded optical system that can improve the definition sense of a displayed image using a diffraction surface.

### SUMMARY

An optical system according to one aspect of the present disclosure is configured to guide light from a display surface to an observation side. The optical system includes a first lens, a second lens disposed on a display surface side relative to the first lens, and a third lens with positive refractive power disposed on the observation side relative to the first lens or on the display surface side relative to the second lens. A surface of the first lens disposed on the display surface side of the first lens includes a first diffraction surface. A surface of the second lens disposed on the observation side of the second lens includes a second diffraction surface. The first diffraction surface and the second diffraction surface are adjacent to each other.

The optical system further comprises a first transmissive reflective surface and a second transmissive reflective surface disposed at positions different from the surface of the first lens disposed on the display surface side of the first lens and the surface of the second lens disposed on the observation side of the second lens. A display apparatus having the above optical system also constitutes another aspect of the present disclosure.

Further features of various embodiments of the disclosure will become apparent from the following description of embodiments with reference to the attached drawings.

### BRIEF DESCRIPTION OF THE DRAWINGS

FIG. 1 is a sectional view of an optical system according to Example 1.

FIG. 2 is an aberration diagram of the optical system according to Example 1.

FIGS. 3A and 3B are partial sectional views of a diffractive optical element (DOE) in Example 1.

FIG. 4 illustrates the diffraction efficiency of the DOE in Example 1.

FIG. 5 is a sectional view of an optical system according to Example 2.

FIG. 6 is an aberration diagram of the optical system according to Example 2.

FIG. 7 illustrates the diffraction efficiency of a DOE in Example 2.

FIG. 8 is a sectional view of an optical system according to Example 3.

FIG. 9 is an aberration diagram of the optical system according to Example 3.

FIG. 10 illustrates the diffraction efficiency of a DOE in Example 3.

FIG. 11 is a sectional view of an optical system according to Example 4.

FIG. 12 is an aberration diagram of the optical system according to Example 4.

FIGS. 13A and 13B are partial sectional views of a DOE in Example 4.

FIG. 14 illustrates the diffraction efficiency of the DOE in Example 4.

FIG. 15 is a sectional view of an optical system according to Example 5.

FIG. 16 is an aberration diagram of the optical system according to Example 5.

FIG. 17 illustrates the diffraction efficiency of a DOE in Example 5.

FIG. 18 is a sectional view of an optical system according to Example 6.

FIG. 19 is an aberration diagram of the optical system according to Example 6.

FIG. 20 is a partial sectional view of a DOE in Example 7.

FIG. 21 is an optical path diagram of an optical system utilizing polarization.

FIG. 22 is another optical path diagram of an optical system utilizing polarization.

FIG. 23 illustrates an HMD using the optical system according to any one of Examples 1 to 7.

FIG. 24 is a partial sectional view of a DOE in Example 8.

FIG. 25 illustrates the diffraction efficiency of the DOE in Example 8.

### DESCRIPTION OF THE EMBODIMENTS

Referring now to the accompanying drawings, a description will be given of examples according to the disclosure.

FIGS. 1, 5, 8, 11, 15, and 18 illustrate sections of optical systems according to Examples 1 to 6, respectively. First, matters common to the optical system according to each example will be described.

The optical system according to each example is an optical system configured to guide light from a display surface ID to a pupil plane SP on the observation side. The display surface ID is a surface on which an original image is displayed on a display element such as an LCD. The observer's eye (pupil) is placed on the pupil plane SP as an observation surface. An aperture stop (diaphragm) may be disposed on the pupil plane SP.

The optical system according to each example includes a first lens L1, a second lens L2 that is disposed on the display surface relative to the first lens L1, and a third lens L3 that has positive refractive power and is disposed on the observation side relative to the first lens L1 or on the display surface side relative to the second lens L2.

A surface of first lens L1 disposed on the display surface side of first lens L1 and a surface of the second lens L2 disposed on the observation side of the second lens L2 are adjacent to each other (next to each other), and each of these surfaces includes a diffraction surface (e.g., first diffraction surface and second diffraction surface) having a diffraction grating. The two diffraction surfaces work together to generate a predetermined phase difference, forming a diffractive optical element (DOE) that converts incident light into diffracted light of a specific diffraction order.

In order to achieve good optical performance with a small number of lenses, the surfaces of the first and second lenses L1 and L2 on which the diffraction surfaces are formed may be both curved surfaces, but if necessary, at least one of them may be flat.

A first transmissive reflective surface HM1 is provided on one of the two surfaces in the optical system other than the surface on which the diffraction surface is formed, and a second transmissive reflective surface HM2 is provided on the other surface. In order to configure the optical system with as few lenses as possible, each transmissive reflective surface may be provided on one of the first to third lenses L1 to L3, and a transmissive reflective surface may be provided on each of the second lens L2 and the third lens L3. A ratio of transmittance to reflectance of each transmissive reflective surface may be 50:50, but is not limited to this ratio.

In the optical systems according to each example, a distance on the optical axis between the pupil plane (eye point) SP and a lens surface closest to the observation side is an eye relief.

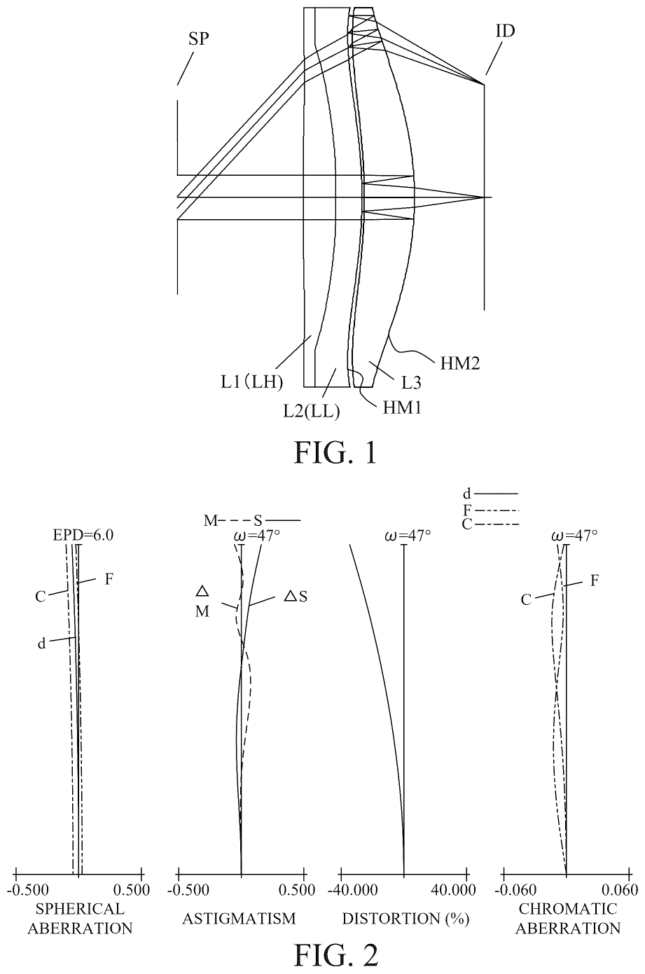

FIGS. 2, 6, 8, 12, 16 and 19 respectively illustrate longitudinal aberrations (spherical aberration, astigmatism, distortion, and chromatic aberration) of the optical systems according to Examples 1 to 6. In the spherical aberration diagrams, EPD indicates a pupil diameter (mm). A solid line indicates a spherical aberration amount for the d-line (wavelength 587.6 nm), an alternate long and short dash line indicates a spherical aberration amount for the C-line (wavelength 656.3 nm), and an alternate long and two short dashes line indicates a spherical aberration amount for the F-line (wavelength 486.1 nm). In the astigmatism diagrams, a solid line AS indicates an astigmatism amount on a sagittal image plane, and a broken line AM indicates an astigmatism amount on a meridional image plane. The distortion diagrams illustrate a distortion amount for the d-line. The chromatic aberration diagrams illustrate a lateral chromatic aberration amount for the C-line and F-line. ω is a half angle of view (°).

There is a one-to-one correspondence between the aberration of a light ray reaching the pupil plane SP by providing a light emitting point on the display surface ID and the aberration of a light ray reaching the display surface ID by providing a light emitting point on the pupil plane SP. Thus, each aberration diagram illustrates the aberration on the display surface ID. Since the pupil diameter of a human eye is about Φ4 mm, the longitudinal aberration is illustrated with the EPD set to Φ4 to 6 mm.

A detailed description will be given of the optical system according to each example. In each example, in a case where a refractive index and an Abbe number are simply mentioned, it means the refractive index at the wavelength (incident wavelength) of the light incident on the optical system and the Abbe number based on the incident wavelength. A refractive index Nd indicates a refractive index for the d-line, which is a part of the incident wavelength, and an Abbe number vd indicates an Abbe number based on the d-line. A partial dispersion ratio θgF indicates a partial dispersion ratio for the g-line and the F-line. The Abbe number vd based on the d-line and the partial dispersion ratio θgF for the g-line and the F-line are defined as the following equations (a) and (b), respectively. Ng, NF, Nd, and NC are refractive indices for the g-line (wavelength 435.8 nm), F-line, d-line, and C-line in the Fraunhofer line, respectively:

$$ν d = ( Nd - 1 ) / ( NF - NC ) \qquad ( a )$$

$$θ gF = ( Ng - NF ) / ( NF - NC ) \qquad ( b )$$

### Example 1

An optical system according to Example 1 illustrated in FIG. 1 will be described. After the description of Example 7, numerical example 1 corresponding to Example 1 will be illustrated.

The optical system according to Example 1 includes, in order from the observation (pupil plane SP) side, a first lens L1, a second lens L2, and a third lens L3. A curved surface of the first lens L1 on the display surface side of the first lens L1 and a curved surface of the second lens L2 on the observation side of the second lens L2 are adjacent to each other with an air layer between them, and each of these curved surfaces has a diffraction surface (e.g., first diffraction surface and second diffraction surface). A first transmissive reflective surface HM1 is provided on the surface of the second lens L2 disposed on the display surface side of the second lens L2, and a second transmissive reflective surface HM2 is provided on the surface of the third lens L3 disposed on the display surface side of the third lens L3. A quarter waveplate is disposed between the first transmissive reflective surface HM1 and the second transmissive reflective surface HM2.

Light emitted from the display surface ID transmits through the second transmissive reflective surface HM2 and the third lens L3, is reflected by the first transmissive reflective surface HM1 towards the display surface side, transmits through the third lens L3 again, and is reflected by the second transmissive reflective surface HM2 towards the observation side. The light then transmits through the third lens L3 again, and transmits through the first transmissive reflective surface HM1, the second lens L2, the two diffraction surfaces, and the first lens L1 in that order before reaching the pupil plane SP.

In this way, providing a transmissive reflective surface to a plurality of surfaces different from a diffraction surface, i.e., not providing a diffraction surface to a reflective surface (between the first and second transmissive reflective surfaces HM1 and HM2) can reduce an angular range of a light beam incident on the diffraction surface. Thereby, flare can be reduced that occurs on a wall surface portion of the diffraction grating provided on the diffraction surface. In other words, the first and second transmissive reflective surfaces HM1 and HM2 may be disposed on the observation side or display surface side relative to the diffraction surface.

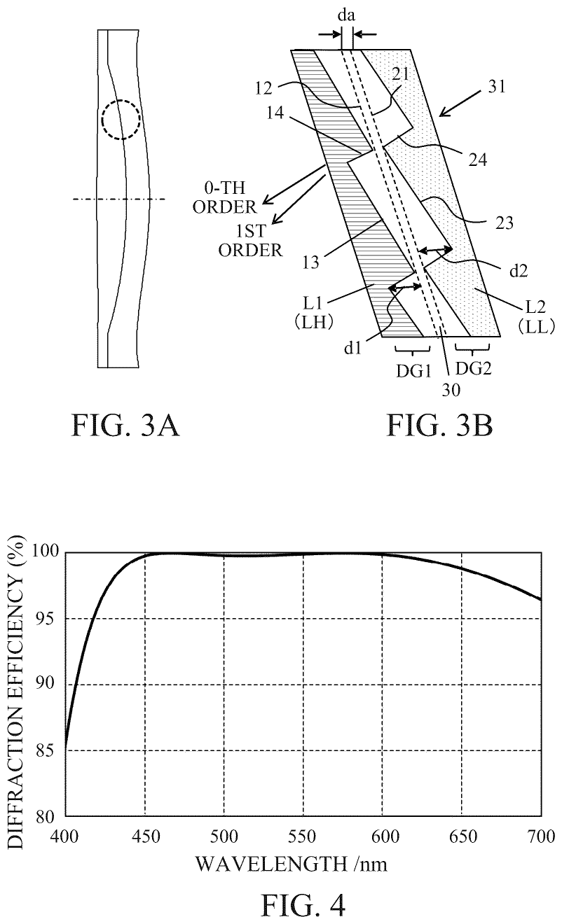

FIG. 3A illustrates a section of the first lens L1 and second lens L2 on which the diffraction surfaces of the optical system according to Example 1 are formed. FIG. 3B illustrates an enlarged view of an area surrounded by a dashed line in FIG. 3A. As illustrated in FIGS. 3A and 3B, a surface of the first lens L1 disposed on the display surface side of the first lens L1 and a surface of the second lens L2 disposed on the observation side of the second lens L2 are curved surfaces with approximately the same curvature, and diffraction gratings DG1 and DG2 are formed on these curved surfaces.

The diffraction grating DG1 is made of the same material as that of the first lens L1 and is molded integrally with the lens surface of the first lens L1 by injection molding. The surface of the first lens L1 disposed on the display surface side of the first lens L1 has a peripheral part that is convex toward the display surface side. The diffraction grating DG1 includes a plurality of slope surface portions 13 and wall surface portions 14 between adjacent slope surface portions 13. The slope surface portions 13 of the diffraction grating DG1 function as a diffraction surface with positive power with respect to an envelope 12 that connects the grating vertices of the diffraction grating DG1.

The diffraction grating DG2 is made of the same material as the second lens L2 and is molded integrally with the lens surface of the second lens L2 by injection molding. The surface on the observation side of the second lens L2 has a peripheral part concave toward the display surface side. The diffraction grating DG2 includes a plurality of slope surface portions 23 and a plurality of wall surface portions 24 between adjacent slope surface portions 23. The slope surface portions 23 of the diffraction grating DG2 function as a diffraction surface having negative power with respect to an envelope 21 connecting the grating vertices of the diffraction grating DG2.

The diffraction gratings DG1 and DG2 are disposed so as to be close to each other via the air layer 30. The diffraction grating DG1, the air layer 30, and the diffraction grating DG2 work together to form a DOE that provides a predetermined phase difference. The diffraction gratings DG1 and DG2 have a concentric grating shape, and have a lens action due to the change in the grating pitch in the radial direction.

The diffraction gratings DG1 and DG2 can be disposed close to each other, for example, by bonding the outer circumference of the lens L1 on which the diffraction grating DG1 is formed to the outer circumference of the lens L2 on which the diffraction grating DG2 is formed. In this case, the accuracy of the shape of the outer circumference outside the effective area of each lens (which will be described later) may be improved. Thereby, the outer circumference of the first lens L1 and the outer circumference of the second lens L2 can contact each other, and a distance da between the envelope 12 connecting the grating vertices of the diffraction grating DG1 and the envelope 21 connecting the grating vertices of the diffraction grating DG2 can be controlled with high accuracy.

It is also important to bond the diffraction gratings DG1 and DG2 with high accuracy in the radial direction. For example, it is possible to improve the positional accuracy in the radial direction by providing a minute alignment shape near the center of the diffraction grating DG1 or DG2 and bonding while the shape is observed. Alternatively, tapered surfaces may be provided on the outer circumferences of the first lens L1 and the second lens L2. By bringing these tapered surfaces into contact with each other, the degree of concentricity between the first lens L1 and the second lens L2 is increased, and the diffraction gratings DG1 and DG2 can be positioned with high accuracy in the radial direction.

The tilt angle of the wall surface portion 14 of the diffraction grating DG1 and the tilt angle of the wall surface portion 24 of the diffraction grating DG2 may be set to be close to the angle of the light beam 31 incident on the diffraction surface. This configuration can reduce flare generated at the wall surface portions 14 and 24. In this case, as illustrated in FIG. 3B, the power generated on the diffraction surface including the diffraction grating DG1 may be positive and the power generated on the diffraction surface including the diffraction grating DG2 may be negative. This configuration can improve the releasability during molding of each diffraction grating while aligning the tilt angle of the wall surface portion 14 of the diffraction grating DG1 and the tilt angle of the wall surface portion 24 of the diffraction grating DG2 with the direction of the incident light beam 31.

In this example, the wavelength region of the light incident on each diffraction surface, i.e., the wavelength region used, is the visible region. The materials and grating heights constituting the diffraction gratings DG1 and DG2 are selected so as to increase the diffraction efficiency of first-order diffracted light throughout the entire visible range.

Next follows a description of the specific configurations of the diffraction gratings DG1 and DG2. In numerical example 1, a cycloolefin-based thermoplastic resin material (Nd=1.544, vd=56.0) is used as the first material forming the diffraction grating DG1 (first lens L1). A polycarbonate-based thermoplastic resin material (Nd=1.671, vd=19.2) is used as the second material forming the diffraction grating DG2 (second lens L2). A refractive index of the air layer 30 between the diffraction gratings DG1 and DG2 is Nd=1.0.

A grating height d1 of the diffraction grating DG1 is 8.00 μm, and a grating height d2 of the diffraction grating DG2 is 5.62 μm. A minimum pitch between the unit gratings of the diffraction gratings DG1 and DG2 is 27.3 μm. The distance da between the envelope 12 connecting the grating vertices of the diffraction grating DG1 and the envelope 21 connecting the grating vertices of the diffraction grating DG2 is 1.50 μm.

Next follows a description of a relationship between a phase difference and diffraction efficiency of the DOE according to this example. In the DOE according to this example, the condition that maximizes the diffraction efficiency of diffraction order m for a wavelength 2 is that the optical path length difference Φ(λ) satisfies the following condition:

$$Φ ( λ ) = ( n 03 - n 01 ) \times d 1 + ( n 02 - n 03 ) \times d 2 = m λ \qquad ( c )$$

In equation (c), n01 is a refractive index of the material forming the diffraction grating DG1 for light of the wavelength λ (d-line in this example), and n02 is a refractive index of the material forming the diffraction grating DG2 for light of wavelength λ. n03 is a refractive index of the layer between the diffraction gratings DG1 and DG2 (air layer 30 in this example) for light of wavelength λ. d1 and d2 are grating heights of the diffraction gratings DG1 and DG2, respectively.

For an incident light beam 31 in FIG. 3B, the diffraction order of light diffracted downward from the 0-th order diffracted light is set as a positive diffraction order, and the diffraction order of light diffracted upward from the 0-th order diffracted light is set as a negative diffraction order. As illustrated in FIG. 3B, in a case where the diffraction grating DG1 on the incident side has a grating shape in which the grating height decreases from bottom to top within one period, the sign of the grating height d1 in equation (c) is negative.

The diffraction efficiency η(λ) at wavelength λ can be expressed as follows:

$$η ( λ ) = sin {c}^{2} \{ π [ m - Φ ( λ ) / λ ] \} \qquad ( d )$$

In equation (d), m is a diffraction order of the diffracted light to be evaluated, and Φ(λ) is an optical path length difference in one unit grating of the diffraction grating for light with the wavelength λ. sinc(x) is a function expressed as sin(x)/x.

This example can achieve high diffraction efficiency in the visible wavelength range in a case where the grating height d1 of diffraction grating DG1 is 8.00 μm and the grating height d2 of diffraction grating DG2 is 5.62 μm. The grating heights d1 and d2 indicate the grating heights in a case where the angle of the wall surface portion of the diffraction grating is orthogonal to the envelope curve connecting the grating vertices. The angle of the wall surface portion can be changed properly according to the incident light.

In this example, the diffraction gratings DG1 and DG2 are made of different materials. More specifically, the diffraction grating DG1 is made of a material with a low refractive index and low dispersion, and the diffraction grating DG2 is made of a material with a higher refractive index and high dispersion.

Next follows a description of the selection of materials for the diffraction grating DG1 (first lens L1) and the diffraction grating DG2 (second lens L2). Since a folded optical system such as that of this example may be compact, aberration may be corrected with a small number of lenses. It may include two to three lenses.

In order to effectively correct various aberrations, especially chromatic aberration, with a small number of lenses, a low-dispersion positive lens and a high-dispersion negative lens may be combined. In order to correct the remaining chromatic aberration that cannot be corrected by the refractive power of the lens, it is conceivable to correct the chromatic aberration using a diffraction surface. In order to obtain high diffraction efficiency in a DOE in which one diffraction surface is sandwiched between two materials, a material with a high refractive index and low dispersion and a material with a low refractive index and high dispersion may be selected, and a necessary refractive index difference between the two materials may be maintained.

However, in general optical lens materials, many high refractive index materials are high dispersion materials, and many low refractive index materials are low dispersion materials. Plastic lenses are often used for the folded optical systems to reduce weight and obtain the aberration correcting effect using aspheric surfaces. There are few high refractive index and low dispersion materials as resin materials for plastic lenses, and as high refractive index and low dispersion materials, resins for replica molding, such as ultraviolet curing resins, are known. However, ultraviolet curable resins have large thickness deviations, and a lens shape with strong power easily impairs the manufacturing stability. Thus, using an injection moldable material, such as thermoplastic resin can stably manufacture lenses with strong power.

This example selects a high refractive index and high dispersion material and

a low refractive index and low dispersion material from moldable thermoplastic resins as the materials for the diffraction gratings DG1 and DG2, respectively. By placing the two diffraction surfaces so that they face each other via a low refractive index layer, the grating heights of the diffraction gratings DG1 and DG2 can be set independently of each other. As a result, high diffraction efficiency can be obtained by combining a diffraction grating made of a material with a high refractive index and high dispersion and a diffraction grating made of a material with a low refractive index and low dispersion.

FIG. 4 illustrates the diffraction efficiency in the annulus at the central part (pitch 852 μm) of the DOE according to numerical example 1. As illustrated in FIG. 4, high diffraction efficiency can be obtained over a wide range of the visible wavelength range.

FIG. 2 illustrates a longitudinal aberration in numerical example 1 with a pupil diameter of Φ6 mm, eye relief of 17 mm, and diopter of 0 diopter. As illustrated in FIG. 2, various aberrations such as longitudinal chromatic aberration, lateral chromatic aberration, and astigmatism are satisfactorily corrected.

In order to achieve both good chromatic aberration correcting effect using the refractive powers of the first lens L1 and second lens L2 and high diffraction efficiency at the diffraction surface, the refractive power of each of the first lens L1 and second lens L2 and the power of the diffraction surface may be properly set.

More specifically, R11 is a radius of curvature of an effective area (referred to as an effective diameter area hereinafter) of the curved surface on the observation side of the first lens L1, and R12 is a radius of curvature of an effective diameter area of the curved surface on the display surface side. The effective area (effective diameter area) is an area through which light rays contribute to imaging on each surface pass, and a diameter of this area (twice as long as a distance between the position farthest from the optical axis in the area and the optical axis) is the effective diameter. In a case where light rays enter the same surface two or more times due to reflection, etc., the largest effective diameter is the effective diameter on that surface. The radius of curvature of the effective diameter area on the surface on which the diffraction surface is formed indicates a radius of curvature of the envelope that connects the tips of the diffraction grating (grating vertices). In a case where the curved surface on the observation side of the first lens L1 and the curved surface on the display surface side of the second lens L2 (the surface on which the diffraction surface is not provided) are aspheric, the radius of curvature may be set to a radius of curvature of a reference spherical surface of the aspheric surface.

In this case, the (positive or negative) sign of the focal length f1e (mm) of the first lens L1 calculated from R11 and R12 may be the same as the sign of the diffraction power PD1 generated at the diffraction surface of the first lens L1. Similarly, R21 is a radius of curvature in the effective diameter area of the curved surface on the observation side of the second lens L2, and R22 is a radius of curvature in the effective diameter area of the curved surface on the display surface side. In this case, the sign of the focal length f2e (mm) of the second lens L2 calculated from R21 and R22 may be the same as the sign of the diffraction power PD2 generated at the diffraction surface of the second lens L2. Thereby, a material with a high refractive index and high dispersion and a material with a low refractive index and low dispersion can be selected as materials for forming the diffraction grating and lenses, and both good chromatic aberration correcting effect and high diffraction efficiency can be achieved.

The sign of the diffraction power is positive in a case where the curvature of the slope surface portion 13 of the diffraction grating is convex toward the display surface side relative to the envelope and the refractive index of the material on the observation side of the diffraction grating is higher than the refractive index of the material on the display surface side, as in the case of the diffraction grating DG1. On the other hand, the sign of the diffraction power is negative in a case where the curvature of the slope surface portion 23 of the diffraction grating is convex toward the display surface side relative to the envelope and the refractive index of the material on the observation side of the diffraction grating is lower than the refractive index of the material on the display surface side, as in the case of the diffraction grating DG2.

The focal length f1e of the first lens L1 is calculated from the radii of curvature R11 and R12 of the effective diameter area of the first lens L1, the refractive index of the first lens L1, and the thickness of the first lens L1 on the optical axis, and does not include the diffraction power. This is similarly applicable to the focal length f2e of the effective diameter area of the second lens L2.

The aspheric shape of each surface in this example is expressed by the following equation (e):

$$x ( h ) = \frac{( \frac{{h}^{2}}{r} )}{1 + \sqrt{{[ 1 - ( 1 + k ) ( \frac{h}{r} ) ]}^{2}}} + {A}_{4} {h}^{4} + + {A}_{6} {h}^{6} + {A}_{8} {h}^{8} + {A}_{10} {h}^{10} + … \qquad ( e )$$

where X is a displacement amount from a surface vertex in the optical axis direction, h is a height from the optical axis in a direction orthogonal to the optical axis, r is a paraxial radius of curvature, k is a conic constant, and Ai (i=4, 6, 8, . . . ) are aspheric coefficients of each order.

Where xh is a displacement amount in the optical axis direction at height h from the optical axis in the effective diameter area of the aspheric surface calculated from equation (e), a radius of curvature Re of the effective diameter area can be calculated from the following equation (f). This radius of curvature Re may be used in place of the radius of curvature of the reference spherical surface described above. In this example (and other examples described later), the radius of curvature Re is used.

$$R e = \frac{( x {h}^{2} + {h}^{2} )}{2 \times x h} \qquad ( f )$$

A layer having a refractive index lower than a refractive index of each of the first and second lenses L1 and L2 may be provided between the diffraction surface of the first lens L1 and the diffraction surface of the second lens L2. Providing the air layer 30 as in this example can achieve high diffraction efficiency even in a case where a diffraction grating made of a material with a high refractive index and high dispersion is combined with a diffraction grating made of a material with a low refractive index and low dispersion. However, the layer does not have to be an air layer, and can be a layer of a low refractive index material (low dispersion material). More specifically, it may be a layer using an aerosol containing an air layer in SiO₂ fine particles.

The optical system according to this example may satisfy at least one of the following inequalities (1) to (8). This is similarly applicable to the optical systems of the other examples described later.

First, the following inequality (1) may be satisfied:

$$0 < 1000 \times ( 1 / f 1 e - 1 / f 2 e ) / ( v 1 - v 2 ) \qquad ( 1 )$$

where f1e (mm) is a focal length of the first lens L1 in the effective diameter area, f2e (mm) is a focal length of the second lens L2 in the effective diameter area, v1 is an Abbe number of the diffraction grating of the first lens L1, and v2 is an Abbe number of the diffraction grating of the second lens L2.

Inequality (1) means a low dispersion material is used for the material of the diffraction grating provided on the lens with positive refractive power in the effective diameter area, and a high dispersion material is used for the material of the diffraction grating provided on the lens with negative refractive power in the effective diameter area. Satisfying inequality (1) can achieve both high diffraction efficiency and high chromatic aberration correcting effect. Inequality (1) may be replaced with inequality (la) below:

$$0.1 \leq 1000 \times ( 1 / f 1 e - 1 / f 2 e ) / ( v 1 - v 2 ) \leq 1. \qquad ( 1 a )$$

Inequality (1) may be replaced with inequality (1b) below:

$$0.15 \leq 1000 \times ( 1 / f 1 e - 1 / f 2 e ) / ( v 1 - v 2 ) \leq 0.90 \qquad ( 1 b )$$

The following inequality (2) may be satisfied:

$$35 \leq v H \leq 70 \qquad ( 2 )$$

where vH is an Abbe number of the diffraction grating of a lens LH of the first lens L1 and the second lens L2, which has a larger Abbe number.

In a case where vH is lower than the lower limit of inequality (2), a difference from the Abbe number of the diffraction grating of the lens LH having a smaller Abbe number and paired with the lens LH becomes too small, and it becomes difficult to achieve high diffraction efficiency. In a case where vH becomes higher than the upper limit of inequality (2), it becomes difficult to select the material of the diffraction grating.

Inequality (2) may be replaced with inequality (2a) below:

$$45 \leq v H \leq 65 \qquad ( 2 a )$$

Inequality (2) may be replaced with inequality (2b) below:

$$50 \leq v H \leq 60 \qquad ( 2 b )$$

The following inequality (3) may be satisfied:

$$10 \leq v L \leq 50 \qquad ( 3 )$$

where vL is an Abbe number of the diffraction grating of lens LL of the first lens L1 and the second lens L2, which has a smaller Abbe number.

In a case where vL becomes lower than the lower limit of inequality (3), it becomes difficult to select a material of the diffraction grating formed by injection molding. In a case where vL becomes higher than the upper limit of inequality (3), a difference from the Abbe number of the diffraction grating of the lens LH having a larger Abbe number becomes too small, and it becomes difficult to achieve high diffraction efficiency.

Inequality (3) may be replaced with inequality (3a) below:

$$13 \leq v L \leq 40 \qquad ( 3 a )$$

Inequality (3) may be replaced with inequality (3b) below:

$$14 \leq v L \leq 30 \qquad ( 3 b )$$

The Abbe numbers of the materials forming the diffraction gratings DG1 and DG2 may be set to values that are properly separated from each other. More specifically, the following inequality (4) may be satisfied:

$$0.01 \leq \vert 1 / vH - 1 / vL \vert \leq 0. 060 \qquad ( 4 )$$

Satisfying inequality (4) can provide high diffraction efficiency in the diffraction gratings DG1 and DG2. Inequality (4) can be rewritten as the following inequality (4′):

$$0.01 \leq \vert 1 / v 1 - 1 / v 2 \vert \leq 0. 060 \qquad ( {4}^{′} )$$

where v1 is an Abbe number of the first lens L1 and v2 is an Abbe number of the second lens L2. Satisfying inequality (4′) can improve the chromatic aberration correcting effect using the refractive powers of the first and second lenses L1 and L2. Inequalities (4) and (4′) can be simultaneously satisfied by making the first lens L1 and the diffraction grating DG1 of the same material, and the second lens L2 and the diffraction grating DG2 of the same material.
   Inequality (4) may be replaced with inequality (4a) below:

$$0.015 \leq \vert 1 / ν H - 1 / ν L \vert \leq 0.05 \qquad ( 4 a )$$

Inequality (4) may be replaced with inequality (4b) below:

$$0.02 \leq \vert 1 / ν H - 1 / ν L \vert \leq 0. 045 \qquad ( 4 b )$$

Inequality (4′) may be replaced with inequality (4c) below:

$$0.015 \leq \vert 1 / ν 1 - 1 / ν2 \vert \leq 0.05 \qquad ( 4 c )$$

Inequality (4′) may be replaced with inequality (4d) below:

$$0.02 \leq \vert 1 / ν 1 - 1 / ν2 \vert \leq 0. 045 \qquad ( 4 d )$$

The following inequality (5) may be satisfied.

$$dL < dH \qquad ( 5 )$$

where dH (μm) is a grating height of the diffraction grating of the lens LH, which has a larger Abbe number among the first lens L1 and the second lens L2, and dL (μm) is a grating height of the diffraction grating of the lens LL, which has a smaller Abbe number.
satisfying inequality (5) in combining a diffraction grating made of a material with a high refractive index and high dispersion with a diffraction grating made of a material with a low refractive index and low dispersion can achieve high diffraction efficiency.

The following inequality (6) may be satisfied:

$$0.6 \leq ( Δ NH \times dH ) / ( Δ NL \times dL ) \leq 1.7 \qquad ( 6 )$$

where NH is a refractive index of the diffraction grating of the lens LH, which has a larger Abbe number among the first lens L1 and the second lens L2, NL is a refractive index of the diffraction grating of the lens LL having a smaller Abbe number, ANH is a refractive index difference between the diffraction grating on the diffraction surface formed on the lens LH and a material layer that contacts the diffraction surface through the diffraction surface, and ΔNL is a refractive index difference between the diffraction grating on the diffraction surface formed on the lens LL and a material layer that contacts the diffraction surface through the diffraction surface.

Satisfying inequality (6) can achieve high diffraction efficiency.

Inequality (6) may be replaced with inequality (6a) below:

$$0.8 \leq ( Δ NH \times dH ) / ( Δ NL \times dL ) \leq 1.5 \qquad ( 6 a )$$

Inequality (6) may be replaced with inequality (6b) below:

$$1. \leq ( Δ NH \times dH ) / ( Δ NL \times dL ) \leq 1.3 \qquad ( 6 b )$$

Satisfying the following inequality (6-1) can achieve good diffraction efficiency over the entire visible range.

$$0. 45 \leq Δ NH \times dH - Δ NL \times dL \leq 0.75 \qquad ( 6 - 1 )$$

Inequality (6-1) may be replaced with inequality (6-1a) below:

$$0.5 \leq Δ NH \times dH - Δ NL \times dL \leq 0.7 \qquad ( 6 - 1 a )$$

Inequality (6-1) may be replaced with inequality (6-1b) below:

$$0.53 \leq Δ NH \times dH - Δ NL \times dL \leq 0.65 \qquad ( 6 - 1 b )$$

The following inequality (7) may be satisfied:

$$4. \leq \vert ( 1 / f 1 e - 1 / f 2 e ) / Pdo \vert \leq 40.0 \qquad ( 7 )$$

where Pdo is diffraction power generated by each diffraction surface.

The diffraction power generated by a diffraction surface is given by a reciprocal of the focal length due to diffraction.

A phase shape P of each diffraction surface is expressed by the following equation (g):

$$P ( h ) = ( 2 π / m {λ}_{0} ) ( {C}_{2} {h}^{2} + {C}_{4} {h}^{4} + {C}_{6} {h}^{6} + … ) \qquad ( g )$$

where h is a height in the direction orthogonal to the optical axis, m is a diffraction order, λ₀ is a designed wavelength, and Ci (i=2, 4, 6, . . . ) is a phase coefficient.

The optical path difference function Ψ of the diffraction surface is expressed by the following equation (h):

$$Ψ ( h ) = {C}_{2} {h}^{2} + {C}_{4} {h}^{4} + {C}_{6} {h}^{6} + … \qquad ( h )$$

The diffraction power Pdo generated by the diffraction surface for the wavelength λ and diffraction order m can be expressed by the following equation (i) using the lowest order phase coefficient C₂.

$$Pdo = - 2 {C}_{2} m λ / {λ}_{0} \qquad ( i )$$

In this example, the design order m of the DOE is the first order, and the designed wavelength is the d-line. The diffraction power Pdo for inequality (7) is a value calculated in equation (i) with λ=λ₀. This is similarly applicable to the other examples described below.

Satisfying inequality (7) enables the chromatic aberration correcting effect to be shared in a well-balanced manner among the first lens L1 and the second lens L2 and the diffraction surfaces, and the chromatic aberration of the entire optical system can be satisfactorily corrected.

Inequality (7) may be replaced with inequality (7a) below:

$$5. \leq \vert ( 1 / f 1 e - 1 / f 2 e ) / Pdo \vert \leq 35. \qquad ( 7 a )$$

Inequality (7) may be replaced with inequality (7b) below:

$$6. \leq \vert ( 1 / f 1 e - 1 / f 2 e ) / Pdo \vert \leq 30.0 \qquad ( 7 b )$$

In a case where a DOE is used for an optical system, there is a tendency to increase the diffractive power in order to correct chromatic aberration. As a result, the diffraction pitch of the diffraction grating reduces. However, in a case where the grating height increases relative to the diffraction pitch, flare generated at the wall surface portion of the diffraction grating increases. Thus, the following inequality (8) may be satisfied:

$$0.8 \leq P min / ( dH + dL ) \leq 4.0 \qquad ( 8 )$$

where Pmin (μm) is a minimum pitch in the diffraction gratings DG1 and DG2.

In a case where Pmin/(dH+dL) becomes higher than the upper limit of inequality (8), the chromatic aberration correcting effect at the diffraction surface decreases or it becomes difficult to achieve high diffraction efficiency. In a case where Pmin/(dH+dL) becomes lower than the lower limit of inequality (8), flare generated at the wall surface portion of the diffraction grating increases.

Inequality (8) may be replaced with inequality (8a) below:

$$1. 0 \leq P min / ( dH + dL ) \leq 3. \qquad ( 8 a )$$

Inequality (8) may be replaced with inequality (8b) below:

$$1. 2 \leq P min / ( dH + dL ) \leq 2.6 \qquad ( 8 b )$$

Adopting the following configuration 1 or 2 utilizing polarization can suppress the reduction in an effective light amount that displays an image and reduce ghost light (undesired light) that transmits through the transmissive reflective surface without even reflecting once.

### Configuration 1 Utilizing Polarization

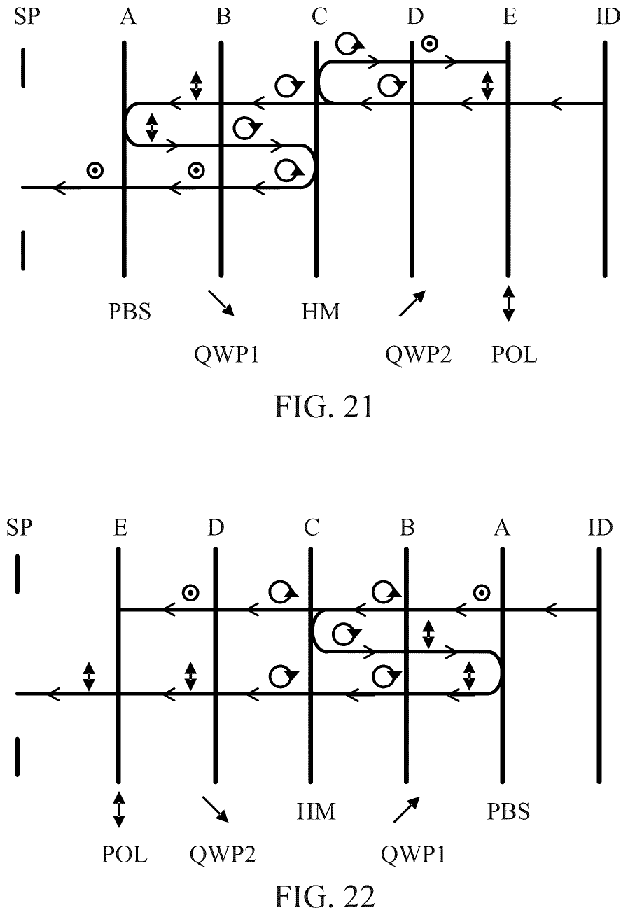

FIG. 21 illustrates configuration 1 utilizing polarization. This configuration 1 has two transmissive reflective surfaces. Here, the first transmissive reflective surface HM1 of the two transmissive reflective surfaces, which is disposed on the observation side is formed by a polarization-selective half-transmissive reflective element (PBS) A, and the second transmissive reflective surface HM2 disposed on the display surface side is formed by a half-mirror (HM) C. A first quarter waveplate (QWP1) B is disposed between the polarization-selective half-transmissive element PBS and the half-mirror HM. A second quarter waveplate (QWP2) D and a linear polarizer (POL) E are disposed between the half-mirror HM and the display surface ID.

The polarization-selective half-transmissive reflective element A is an element configured to reflect linearly polarized light with the same polarization direction as that when it passed through the linear polarizer E, and to transmit linearly polarized light with a polarization direction orthogonal to this direction. The polarization-selective half-transmissive reflective element A is, for example, a wire grid polarizer or a reflective polarizer with a phase difference film laminated configuration. In this case, the wire grid forming surface and the phase difference film surface of the polarization-selective half-transmissive reflective element A serves as a transmissive reflective surface.

Each of the first quarter waveplate B and the second quarter waveplate D has a slow axis tilted by 45° relative to the polarization transmission axis of the linear polarizer E. The first quarter waveplate B and the second quarter waveplate D may be disposed so that their respective slow axes are tilted by 90° to each other. Due to this arrangement, the wavelength dispersion characteristics of the wave plates are offset in a case where light transmits through the first quarter waveplate B and the second quarter waveplate D.

The half-mirror C is a half-mirror formed, for example, by a dielectric multilayer film or metal deposition, and functions as a transmissive reflective surface. The linear polarizer E is, for example, an absorptive linear polarizer.

Unpolarized light emitted from the display surface ID is converted into linearly polarized light by the linear polarizer E. The linearly polarized light is converted into circularly polarized light by the second quarter waveplate D, and the circularly polarized light enters the half-mirror C. A part of the light that entered the half-mirror C is reflected by the half-mirror C and returns to the second quarter waveplate D as circularly polarized light in the opposite direction to the incident direction.

The circularly polarized light in the reverse direction that has returned to the second quarter waveplate D is returned to the linear polarizer E by the second quarter waveplate D as linearly polarized light in a direction orthogonal to that when it first passed through the linear polarizer E, and is absorbed by the linear polarizer E.

On the other hand, a part of the light that reaches the half-mirror C transmits through it and is turned into linearly polarized light by the first quarter waveplate B in the same polarization direction as that when it passed through the linear polarizer E, and enters the polarization-selective half-transmissive reflective element A. The polarization-selective half-transmissive reflective element A reflects linearly polarized light in the same polarization direction as that when it passed through the linear polarizer E due to its polarization selectivity.

The light reflected by the polarization-selective half-transmissive reflective element A is converted by the first quarter waveplate B into circularly polarized light in the same direction as that when the light was turned into first circularly polarized by the second quarter waveplate D, and this circularly polarized light enters the half-mirror C. The light reflected by the half-mirror C becomes turned into circularly polarized light in the opposite direction to that when the light was incident, and enters the first quarter waveplate B. Thereby, the circularly polarized light is converted into linearly polarized light in a polarization direction orthogonal to that when the light first passed through the linear polarizer E, and enters the polarization-selective half-transmissive reflective element A.

Of the linearly polarized light incident on the polarization-selective half-transmissive reflective element A, the linearly polarized light with a polarization direction orthogonal to that when the light passed through the linear polarizer E transmits through the polarization-selective half-transmissive reflective element A and is guided to the pupil plane SP.

Due to the above optical actions, of the light from the display surface ID, the light that transmits through the half-mirror HM, is reflected by the polarization-selective half-transmissive reflector PBS, is reflected by the half-mirror HM, and transmits through the polarization-selective half-transmissive reflector PBS is directed to the pupil plane SP.

### Configuration 2 Utilizing Polarization

FIG. 22 illustrates configuration 2 utilizing polarization. Configuration 2 also has two transmissive reflective surfaces. However, the first transmissive reflective surface HM1 disposed on the observation side is a half-mirror (HM) C, and the second transmissive reflective surface HM2 disposed on the display surface side is a polarization-selective half-transmissive element (PBS) A. A first quarter waveplate (QWP1) B is disposed between the polarization-selective half-transmissive element PBS and the half-mirror HM. A linear polarizer (POL) E and a second quarter waveplate (QWP2) D are disposed between the half-mirror HM and the pupil plane SP. The configuration and optical axis orientation of each polarizing element according to configuration 2 are similar to those of configuration 1.

Unpolarized light emitted from the display surface ID enters the polarization-selective half-transmissive reflective element A. Of the unpolarized light, linearly polarized light with a polarization direction orthogonal to the transmission axis of the linear polarizer E transmits through the polarization-selective half-transmissive reflective element A. The light that transmits through the polarization-selective half-transmissive reflective element A is converted into circularly polarized light by the first quarter waveplate B, and this circularly polarized light enters the half-mirror C.

A part of the light that enters the half-mirror C transmits through it and enters the second quarter waveplate D. The circularly polarized light that enters the second quarter waveplate D is converted by the second quarter waveplate D into linearly polarized light in a polarization direction orthogonal to the transmission axis of the linear polarizer E, and enters the linear polarizer E, where it is absorbed.

A part of the circularly polarized light that enters the half-mirror C is reflected by it and becomes circularly polarized light in the reverse direction, and returns to the first quarter waveplate B. The circularly polarized light in the reverse direction that returns to the first quarter waveplate B is converted by the first quarter waveplate B into linearly polarized light in a polarization direction parallel to the transmission axis of the linear polarizer E, and this linearly polarized light enters the polarization-selective half-transmissive reflective element A. Due to the polarization selectivity of the polarization-selective half-transmissive reflective element A, linearly polarized light in a polarization direction parallel to the transmission axis of the linear polarizer E is reflected by the polarization-selective half-transmissive reflective element A.

The linearly polarized light reflected by the polarization-selective half-transmissive reflective element A is converted into circularly polarized light with a direction opposite to that when it was turned into circularly polarized by the first quarter waveplate B, and enters the half-mirror C. The circularly polarized light that transmits through the half-mirror C enters the second quarter waveplate D and is converted into linearly polarized light with a polarization direction parallel to the transmission axis of the linear polarizer E, and this linearly polarized light transmits through the linear polarizer E and is guided to the pupil plane SP.

Due to the above optical action, of the light from the display surface ID, the light that transmits through the polarization-selective half-transmissive reflector PBS, is reflected by the half-mirror HM, is reflected by the polarization-selective half-transmissive reflector PBS, and transmits through the half-mirror HM is guided to the pupil plane SP.

### Example 2

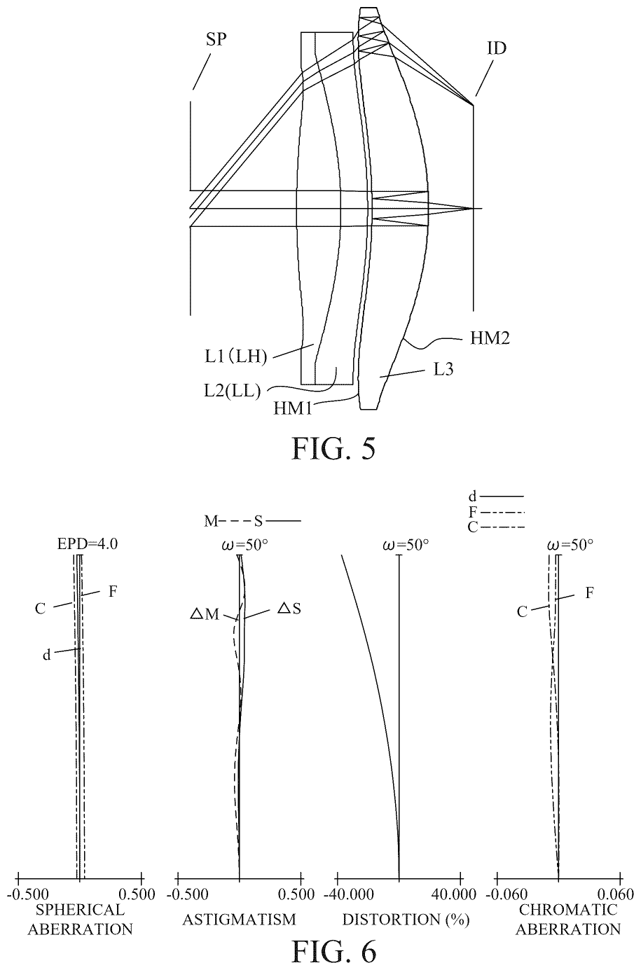

An optical system according to Example 2 illustrated in FIG. 5 will be described. After the description of Example 7, numerical example 2 corresponding to Example 2 will be illustrated.

The optical system according to this example includes, in order from the observation (pupil plane SP) side, a first lens L1, a second lens L2, and a third lens L3. The curved surface on the display surface side of the first lens L1 and the curved surface on the observation side of the second lens L2 are disposed adjacent to each other via an air layer, and a diffraction surface is formed on each curved surface.

A first transmissive reflective surface HM1 is provided on the surface on the observation side of the third lens L3, and a second transmissive reflective surface HM2 is provided on the surface on the display surface side of the third lens L3. A quarter waveplate is disposed between the first transmissive reflective surface HM1 and the second transmissive reflective surface HM2.

Light emitted from the display surface ID transmits through the second transmissive reflective surface HM2 and the third lens L3, is reflected by the first transmissive reflective surface HM1 towards the display surface, transmits through the third lens L3 again and is reflected by the second transmissive reflective surface HM2 towards the observation side. The light then transmits through the third lens L3 again, transmits through the first transmissive reflective surface HM1, the second lens L2, the two diffraction surfaces and the first lens L1 in this order and reaches the pupil plane SP.

In this example, the diffraction grating DG1 formed on the surface on the display surface side of the first lens L1 and the diffraction grating DG2 formed on the surface on the observation side of the second lens L2 have the configuration illustrated in FIG. 3B, similarly to Example 1.

In numerical example 2, a cycloolefin-based thermoplastic resin material (Nd=1.544, vd=56.0) is used as the first material forming the diffraction grating DG1 (first lens L1). A polycarbonate-based thermoplastic resin material (Nd=1.681, vd=18.2) is used as the second material forming the diffraction grating DG2 (second lens L2). An air layer (Nd=1.0) is provided between the diffraction gratings DG1 and DG2.

A grating height d1 of the diffraction grating DG1 is 7.50 μm, and a grating height d2 of the diffraction grating DG2 is 5.14 μm. A minimum pitch between the unit gratings of the diffraction gratings DG1 and DG2 is 22.0 μm. A distance da between the envelope connecting the grating vertices of the diffraction grating DG1 and the envelope connecting the grating vertices of the diffraction grating DG2 is 1.50 μm.

FIG. 6 illustrates a longitudinal aberration in numerical example 2 with a pupil diameter of Φ4 mm, an eye relief of 12 mm, and a diopter of 0 diopters. As illustrated in FIG. 6, various aberrations such as longitudinal chromatic aberration, lateral chromatic aberration, and astigmatism are satisfactorily corrected.

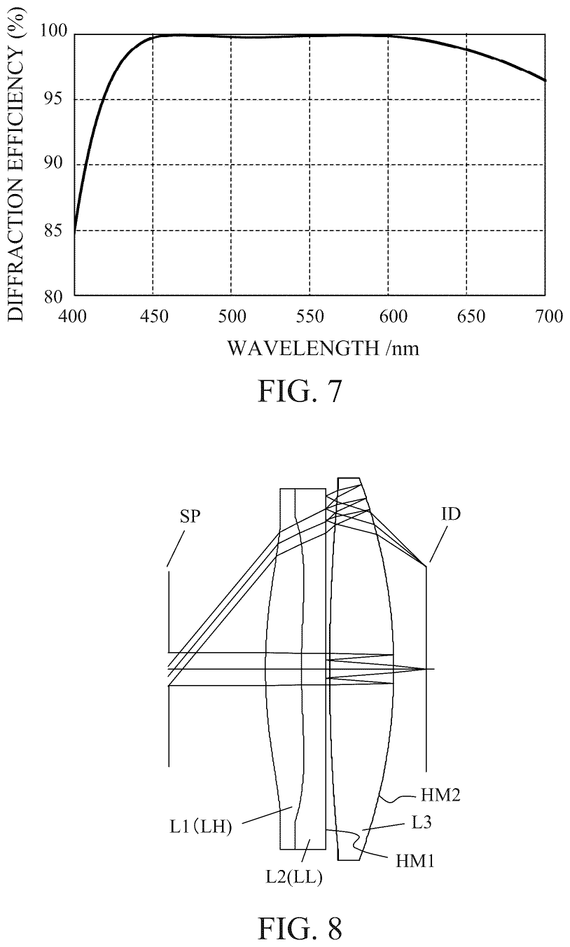

FIG. 7 illustrates the diffraction efficiency in the annulus at the central part (pitch 1044 μm) of the DOE according to numerical example 2. As illustrated in FIG. 7, high diffraction efficiency is obtained over a wide range of the visible wavelength range.

### Example 3

An optical system according to Example 3 illustrated in FIG. 8 will be described. After the description of Example 7, numerical example 3 corresponding to Example 3 will be illustrated.

In Examples 1 and 2, the first and second transmissive reflective surfaces HM1, HM1 are curved surfaces. In contrast, in this example, the first transmissive reflective surface HM1 is flat, which makes it easier to form the first transmissive reflective surface HM1.

The optical system according to this example includes, in order from the observation (pupil plane SP) side, a first lens L1, a second lens L2, and a third lens L3. The curved surface of the first lens L1 on the display surface side and the curved surface of the second lens L2 on the observation side are disposed adjacent to each other via an air layer, and a diffraction surface is formed on each curved surface.

A first transmissive reflective surface HM1 is provided on the surface of the second lens L2 on the display surface side, and a second transmissive reflective surface HM2 is provided on the surface of the third lens L3 on the display surface side. A quarter waveplate is disposed between the first transmissive reflective surface HM1 and the second transmissive reflective surface HM2.

Light emitted from the display surface ID transmits through the second transmissive reflective surface HM2 and the third lens L3, is reflected by the first transmissive reflective surface HM1 towards the display surface side, transmits through the third lens L3 again, and is reflected by the second transmissive reflective surface HM2 towards the observation side. Thereafter, the light transmits through the third lens L3 again, transmits through the first transmissive reflective surface HM1, the second lens L2, the two diffraction surfaces, and the first lens L1 in this order, and reaches the pupil plane SP.

In this example, the diffraction grating DG1 formed on the display surface side of the first lens L1 and the diffraction grating DG2 formed on the surface on the observation side of the second lens L2 have the configuration illustrated in FIG. 3B, similarly to Example 1.

In numerical example 3, a cycloolefin-based thermoplastic resin material (Nd=1.494, vd=57.4) is used as the first material forming the diffraction grating DG1 (first lens L1). A polycarbonate-based thermoplastic resin material (Nd=1.681, vd=18.2) is used as the second material forming the diffraction grating DG2 (second lens L2). An air layer (Nd=1.0) is provided between the diffraction gratings DG1 and DG2.

A grating height d1 of the diffraction grating DG1 is 7.50 μm, and a grating height d2 of the diffraction grating DG2 is 4.58 μm. A minimum pitch between the unit gratings of the diffraction gratings DG1 and DG2 is 21.0 μm. A distance da between the envelope connecting the grating vertices of the diffraction grating DG1 and the envelope connecting the grating vertices of the diffraction grating DG2 is 1.50 μm.

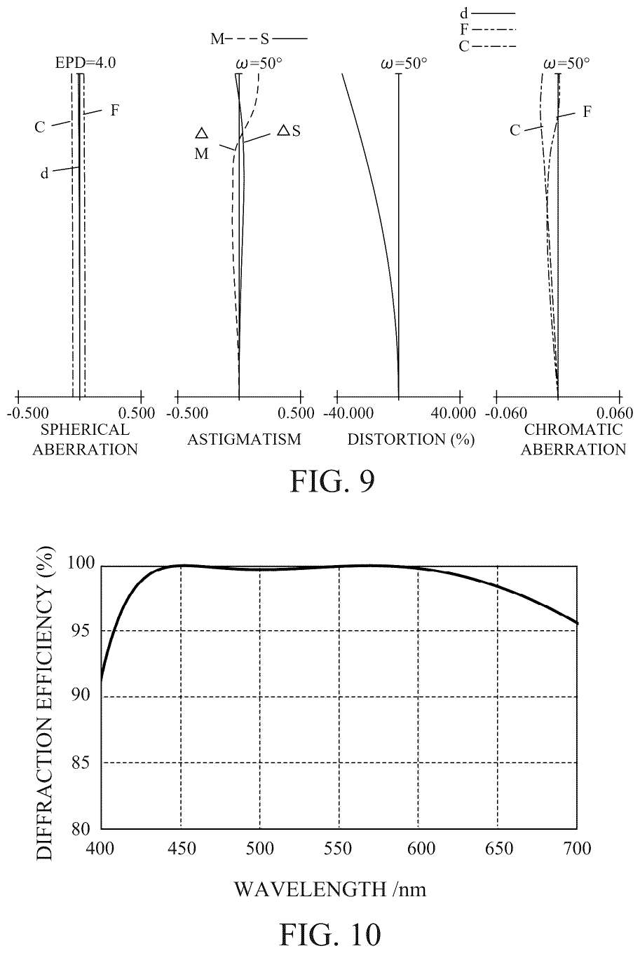

FIG. 9 illustrates a longitudinal aberration in numerical example 3 with a pupil diameter of Φ4 mm, an eye relief of 12 mm, and a diopter of 0. As illustrated in FIG. 9, various aberrations such as longitudinal chromatic aberration, lateral chromatic aberration, and astigmatism are satisfactorily corrected.

FIG. 10 illustrates the diffraction efficiency in the annulus at the central part (pitch 1021 μm) of the DOE in numerical example 3. As illustrated in FIG. 10, high diffraction efficiency is obtained over a wide range of the visible wavelength range.

### Example 4

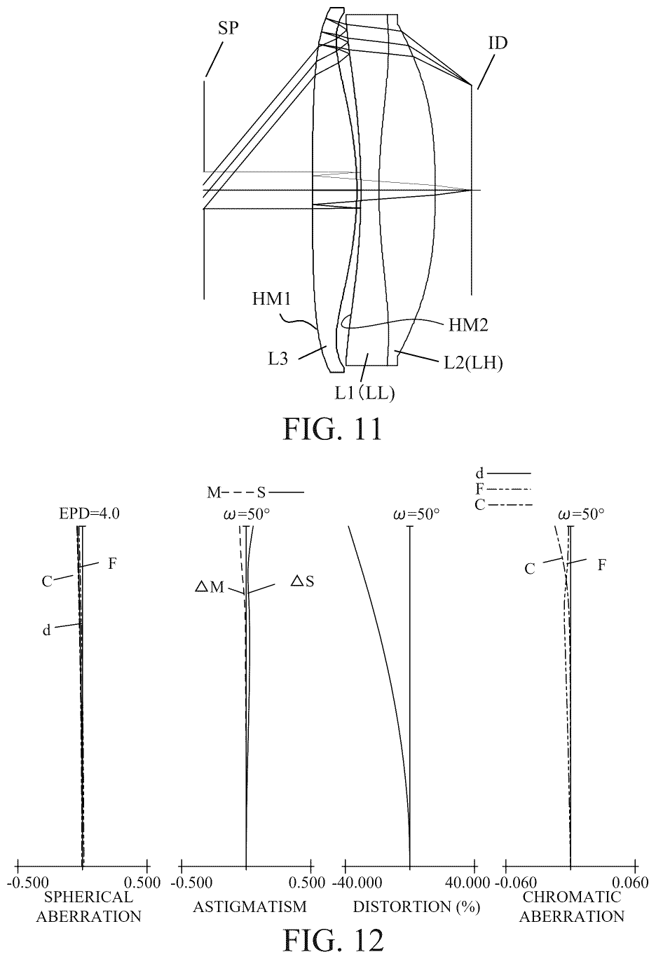

An optical system according to Example 4 illustrated in FIG. 11 will be described. After the description of Example 7, the numerical value according to Example 4 corresponding to Example 4 is illustrated. In Examples 1 to 3, the third lens L3 and the first and second transmissive reflective surfaces HM1 and HM2 are disposed on the display surface side relative to the two diffraction surfaces. In contrast, this example has a different configuration.

The optical system according to this example includes, in order from the observation (pupil plane SP) side, the third lens L3, the first lens L1, and the second lens L2. The curved surface on the display surface side of the first lens L1 and the curved surface on the observation side of the second lens L2 are disposed adjacent to each other via an air layer, and a diffraction surface is formed on each curved surface.

A first transmissive reflective surface HM1 is provided on the surface on the observation side of the third lens L3, and a second transmissive reflective surface HM2 is provided on the surface on the observation side of the first lens L1. A quarter waveplate is disposed between the first transmissive reflective surface HM1 and the second transmissive reflective surface HM2.

Light emitted from the display surface ID transmits through the second lens L2 and the first lens L1 in this order, transmits through the second transmissive reflective surface HM2 and the third lens L3, is reflected by the first transmissive reflective surface HM1 towards the display surface, transmits through the third lens L3 again, and is reflected by the second transmissive reflective surface HM2 towards the observation side. The light then transmits through the third lens L3 again and further transmits through the first transmissive reflective surface HM1 to reach the pupil plane SP.

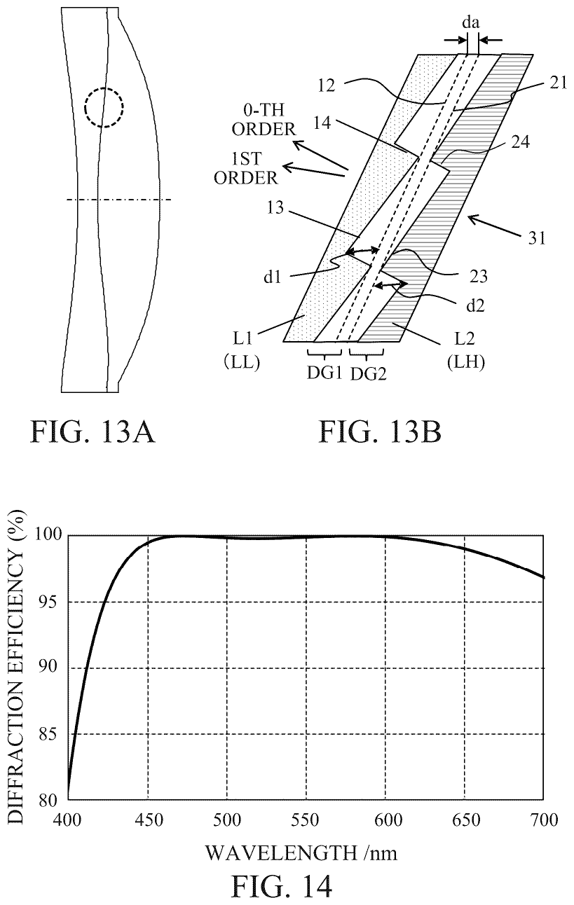

FIG. 13A illustrates a section of the first lens L1 and second lens L2 in this example. FIG. 13B illustrates an enlarged view of an area enclosed by the dashed line in FIG. 13A. As illustrated in FIGS. 13A and 13B, the surface on the image plane side of the first lens L1 and the surface on the observation side of the second lens L2 are curved surfaces with approximately the same curvature, and diffraction gratings DG1 and DG2 are formed on respective curved surfaces.

The diffraction grating DG1 is made of the same material as that of the first lens L1 and is molded integrally with the lens surface of the first lens L1 by injection molding. The surface on the display surface side of the first lens L1 has a peripheral part concave toward the display surface side. The diffraction grating DG1 includes a plurality of slope surface portions 13 and wall surface portions 14 between adjacent slope surface portions 13. The slope surface portions 13 of the diffraction grating DG1 function as a diffraction surface having negative power with respect to the envelope 12 connecting the grating vertices of the diffraction grating DG1.

The diffraction grating DG2 is made of the same material as that of the second lens L2 and is molded integrally with the lens surface of the second lens L2 by injection molding. The diffraction grating DG2 includes a plurality of slope surface portions 23 and wall surface portions 24 between adjacent slope surface portions 23. The slope surface portions 23 of diffraction grating DG2 function as a diffraction surface having positive power with respect to an envelope 21 connecting the grating vertices of diffraction grating DG2.

The diffraction gratings DG1 and DG2 are disposed in close proximity to each other via an air layer 30, and the diffraction grating DG1, air layer 30 and diffraction grating DG2 are configured to obtain the required phase difference in combination.

In the optical system according to this example, as illustrated by a light beam 31 in FIG. 13B, a light beam is incident at an angle from the bottom to the top in the figure. At this time, the diffraction power generated at the diffraction surface of diffraction grating DG1 may be set to be negative and the diffraction power generated at the diffraction surface of diffraction grating DG2 may be set to be positive. Thereby, the angle between the wall surface portions 14 of the diffraction grating DG1 and the wall surface portions 24 of the diffraction grating DG2 can be aligned with the direction of the incident light beam 31, and the releasability during molding of each diffraction grating can be improved.

In numerical example 4, a polycarbonate-based thermoplastic resin material (Nd=1.681, vd=18.2) is used as the first material for forming the diffraction grating DG1 (first lens L1). A cycloolefin-based thermoplastic resin material (Nd=1.544, vd=56.0) is used as the second material for forming the diffraction grating DG2 (second lens L2). An air layer (Nd=1.0) is provided between the diffraction gratings DG1 and DG2.

A grating height d1 of the diffraction grating DG1 is 5.37 μm, and a grating height d2 of the diffraction grating DG2 is 7.80 μm. A minimum pitch between the unit gratings of the diffraction gratings DG1 and DG2 is 22.0 μm. A distance da between the envelope 12 connecting the grating vertices of the diffraction grating DG1 and the envelope 21 connecting the grating vertices of the diffraction grating DG2 is 1.50 μm.

FIG. 12 illustrates a longitudinal aberration in the numerical example 4 with a pupil diameter of Φ4 mm, an eye relief of 12 mm, and a diopter of 0 diopters. As illustrated in FIG. 12, various aberrations such as longitudinal chromatic aberration, lateral chromatic aberration, and astigmatism are satisfactorily corrected.

FIG. 14 illustrates the diffraction efficiency in the annulus at the central part (pitch 922 μm) of the DOE in the numerical example 4. As illustrated in FIG. 14, high diffraction efficiency is obtained over a wide range of the visible wavelength range.

### Example 5

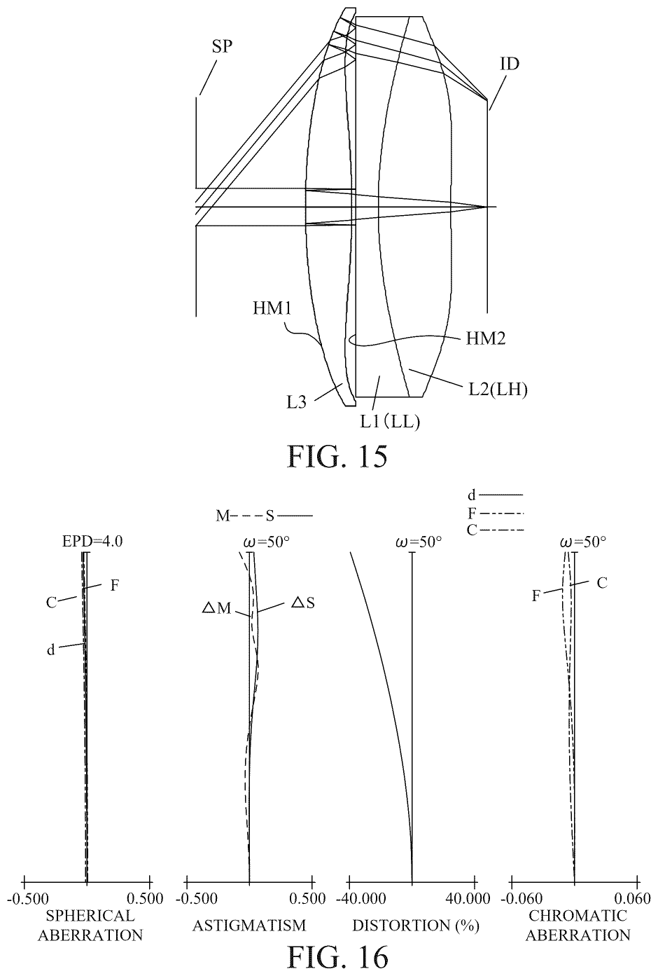

An optical system according to Example 5 illustrated in FIG. 15 will be described. After the description of Example 7, the numerical example 5 corresponding to Example 5 will be illustrated.

Similarly to Example 4, the optical system according to this example also includes, in order from the observation (pupil plane SP) side, a third lens L3, a first lens L1, and a second lens L2. The curved surface on the display surface side of the first lens L1 and the curved surface on the observation side of the second lens L2 are disposed adjacent to each other via an air layer, and a diffraction surface is formed on each curved surface.

A first transmissive reflective surface HM1 is provided on the surface on the observation side of the third lens L3, and a second transmissive reflective surface HM2 is provided on the surface on the observation side of the first lens L1. A quarter waveplate is disposed between the first transmissive reflective surface HM1 and the second transmissive reflective surface HM2.

Light emitted from the display surface ID transmits through the second lens L2 and the first lens L1 in that order, transmits through the second transmissive reflective surface HM2 and the third lens L3, is reflected by the first transmissive reflective surface HM1 towards the display surface, transmits through the third lens L3 again, and is reflected by the second transmissive reflective surface HM2 towards the observation side. The light then transmits through the third lens L3 again and further transmits through the first transmissive reflective surface HM1 to reach the pupil plane SP.

In this example, the diffraction grating DG1 formed on the surface on the display surface side of the first lens L1 and the diffraction grating DG2 formed on the surface on the observation side of the second lens L2 have the configuration illustrated in FIG. 13B, similarly to Example 4.

In numerical example 5, a polyester-based thermoplastic resin material (Nd=1.641, vd=22.3) is used as the first material for forming the diffraction grating DG1 (first lens L1). A cycloolefin-based thermoplastic resin material (Nd=1.530, vd=55.5) is used as the second material forming the diffraction grating DG2 (second lens L2). An air layer (Nd=1.0) is provided between the diffraction gratings DG1 and DG2.

The grating height d1 of the diffraction grating DG1 is 6.29 μm, and the grating height d2 of the diffraction grating DG2 is 8.70 μm. The minimum pitch between the unit gratings of the diffraction gratings DG1 and DG2 is 22.0 μm. The distance da between the envelope connecting the grating vertices of the diffraction grating DG1 and the envelope connecting the grating vertices of the diffraction grating DG2 is 1.50 μm.

FIG. 16 illustrates a longitudinal aberration in numerical example 5 with a pupil diameter of Φ4 mm, an eye relief of 12 mm, and a diopter of 0 diopters. As illustrated in FIG. 16, various aberrations such as longitudinal chromatic aberration, lateral chromatic aberration, and astigmatism are well corrected.

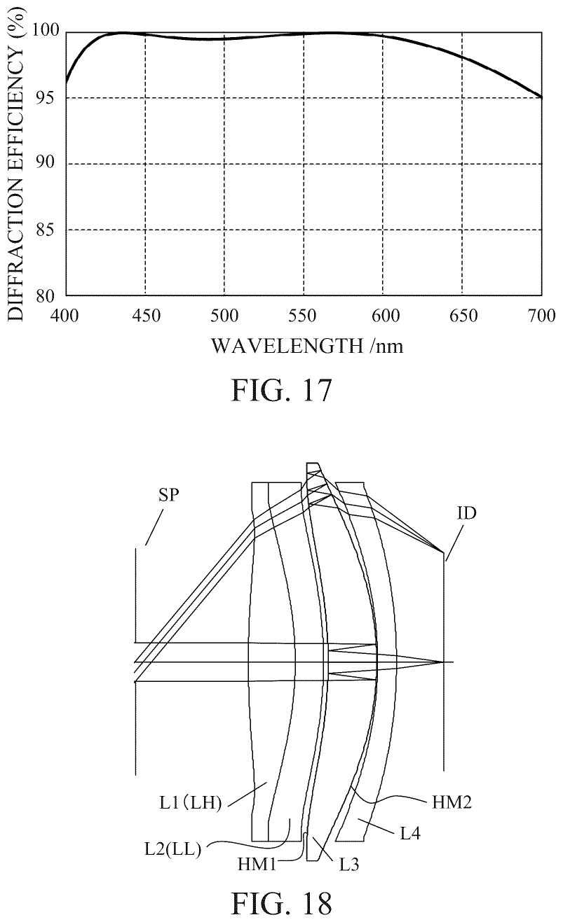

FIG. 17 illustrates the diffraction efficiency in the annulus at the central part (pitch 636 μm) of the DOE of numerical example 5. As illustrated in FIG. 17, high diffraction efficiency is obtained over a wide range of the visible wavelength range.

### Example 6

An optical system according to Example 6 illustrated in FIG. 18 will be described. After the description of Example 7, numerical example 6 corresponding to Example 6 will be illustrated.

The optical system according to this example includes, in order from the observation (pupil plane SP) side, a first lens L1, a second lens L2, a third lens L3, and a fourth lens L4. The curved surface on the display surface side of the first lens L1 and the curved surface on the observation side of the second lens L2 are disposed adjacent to each other via an air layer, and a diffraction surface is formed on each curved surface.

A first transmissive reflective surface HM1 is provided on the surface on the observation side of the third lens L3, and a second transmissive reflective surface HM2 is provided on the surface on the display surface side of the third lens L3. A quarter waveplate is disposed between the first transmissive reflective surface HM1 and the second transmissive reflective surface HM2.

Light emitted from the display surface ID transmits through the fourth lens L4, the second transmissive reflective surface HM2, and the third lens L3, is reflected by the first transmissive reflective surface HM1 toward the display surface side, transmits through the third lens L3 again, and is reflected by the second transmissive reflective surface HM2 toward the observation side. The light then transmits through the third lens L3 again, transmits through the first transmissive reflective surface HM1, the second lens L2, the two diffraction surfaces, and the first lens L1 in this order, and reaches the pupil plane SP.

In this example, the diffraction grating DG1 formed on the display surface side of the first lens L1 and the diffraction grating DG2 formed on the observation side of the second lens L2 have the configuration illustrated in FIG. 3B, similar to Example 1. Furthermore, in this example (numerical example 6), the same material as that of Example 2 (numerical example 2) is used.

A grating height d1 of the diffraction grating DG1 is 7.50 μm, and a grating height d2 of the diffraction grating DG2 is 5.14 μm. A minimum pitch between the unit gratings of the diffraction gratings DG1 and DG2 is 27.4 μm. A distance da between the envelope connecting the grating vertices of the diffraction grating DG1 and the envelope connecting the grating vertices of the diffraction grating DG2 is 1.50 μm.

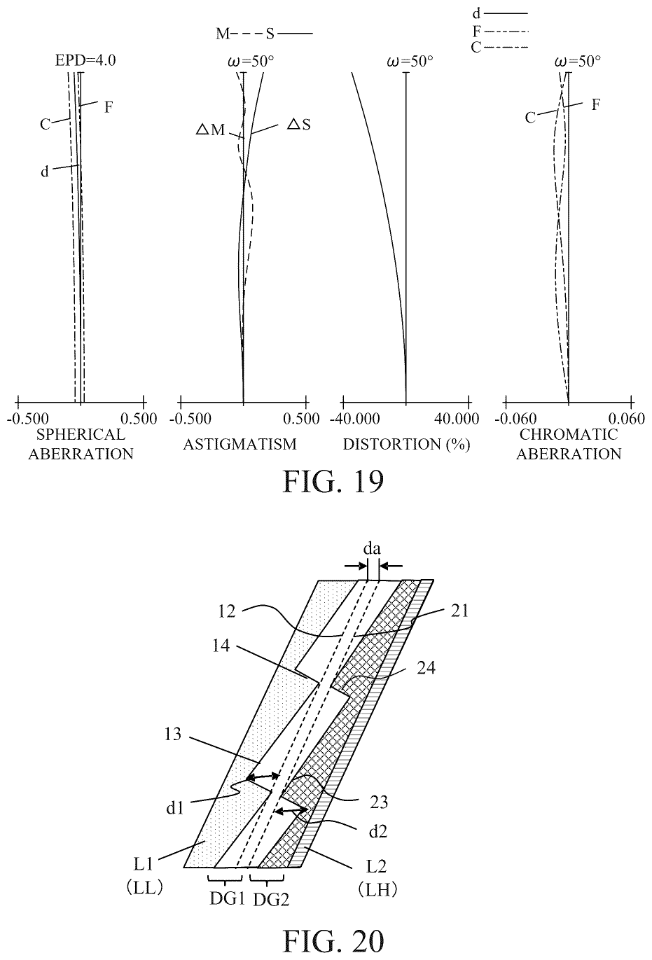

FIG. 19 illustrates a longitudinal aberration in numerical example 6 with a pupil diameter of Φ4 mm, an eye relief of 12 mm, and a diopter of 0 diopter. As illustrated in FIG. 19, various aberrations such as longitudinal chromatic aberration, lateral chromatic aberration, and astigmatism are satisfactorily corrected.

The diffraction efficiency of the DOE in numerical example 6 is the same as that illustrated in FIG. 7 in Example 2, and high diffraction efficiency is obtained over a wide range in the visible wavelength range.

The optical systems according to Examples 1 to 6 include three or four lenses, but the number of lenses is not limited to this example. For example, an optical system with even better aberration correction can be obtained by adding a thin replica-molded lens on the lens surface made of injection molding material.

The optical systems according to Examples 1 to 6 also have two diffraction surfaces, and the combination of these two diffraction surfaces produces the required phase difference. However, a diffraction surface other than the two diffraction surfaces may be included, and an optical system that has a better chromatic aberration correcting effect can be obtained by having three or more diffraction surfaces.

### Example 7

FIG. 20 illustrates an enlarged view of the DOE used in the optical system according to Example 7, which corresponds to an area enclosed by a dashed line in FIG. 13A. The DOE according to this example is a variation of the DOEs according to Examples 4 and 5.

In the DOEs according to Examples 1 to 6, the first lens L1 and the diffraction grating DG1 are made of the same material, and the second lens L2 and the diffraction grating DG2 are made of the same material, so that the lens and the diffraction grating are integrally formed. On the other hand, in this example, the lens and the diffraction grating are formed separately and integrated.

As illustrated in FIG. 20, the second lens L2 and the diffraction grating DG2 are formed separately and integrated by bonding them together. The materials of the second lens L2 and the diffraction grating DG2 may be the same or different.

Forming the second lens L2 and the diffraction grating DG2 separately in this way can increase the freedom of selecting the material of the diffraction grating DG2. As a result, it becomes easier to achieve high diffraction efficiency. In addition, since the total thickness of the diffraction grating DG2 can be reduced, the molding stability of the diffraction grating is improved, and it becomes easier to obtain a highly accurate diffraction grating shape. More specifically, the filling performance of the resin at the tip of the grating by injection molding or the like is improved, and it becomes easier to achieve high diffraction efficiency.

The first lens L1 and the diffraction grating DG1 may be molded separately and then integrated.

### Example 8

A DOE according to this Example 8 is a variation of the DOE according to Example 4. FIG. 24 illustrates an enlarged view of the DOE for the optical system according to Example 8, which corresponds to an area enclosed by the dashed line in FIG. 13A.

The DOEs in Examples 1 to 6 have an air layer (Nd=1.0) between the diffraction grating DG1 and the diffraction grating DG2. In contrast, in this example, the material layer 40 that contacts the diffraction grating DG1 via the slope surface portion 13 is made of a resin material.

A diffraction grating DG1 is made of the same material as that of the first lens L1 and is integrated with the lens surface of the first lens L1 by injection molding, and is made of a material layer 40 formed by molding a different material layer on the surface of the diffraction grating DG1. The diffraction grating DG1 acts as a diffraction surface that has negative power with respect to the envelope 12 that connects the grating vertices of the diffraction grating DG1.

A diffraction grating DG2 is made of the same material as that of the second lens L2 and is integrated with the lens surface of the second lens L2 by injection molding. The diffraction grating DG2 is made of a plurality of slope surface portions 23 and a plurality of wall surface portions 24 between adjacent incident surface portions 23. The slope surface portion 23 of the diffraction grating DG2 acts as a diffraction surface having positive power with respect to the envelope 21 connecting the grating vertices of the diffraction grating DG2.

The diffraction gratings DG1 and DG2 are disposed in close proximity via the air layer 30, and the diffraction gratings DG1, the air layer 30, and the diffraction grating DG2 are configured to achieve the required phase difference in combination.

In the optical system according to this example, as illustrated by the light beam 31 in FIG. 24, a light beam is incident at an angle from bottom to top in the figure. At this time, the diffraction power generated at the diffraction surface of the diffraction grating DG1 may be negative and the diffraction power generated at the diffraction surface of the diffraction grating DG2 may be positive. Thereby, the angle between the wall surface portion 14 of the diffraction grating DG1 and the wall surface portion 24 of the diffraction grating DG2 can be aligned with the direction of the incident light beam 31, and the releasability during molding of each diffraction grating can be improved.

In numerical example 8, a polycarbonate-based thermoplastic resin material (Nd=1.681, vd=18.2) is used as the first material forming the diffraction grating DG1 (first lens L1).

An acrylic ultraviolet curing resin(Nd=1.524, vd=51.6) is used as the material layer that contacts the diffraction grating DG1 via the slope surface portion 13.

A cycloolefin-based thermoplastic resin material (Nd=1.544, vd=56.0) is used as the second material forming the diffraction grating DG2 (second lens L2). An air layer (Nd=1.0) is provided between the diffraction gratings DG1 and DG2.

A grating height d1 of the diffraction grating DG1 is 5.98 μm, and a grating height d2 of the diffraction grating DG2 is 2.80 μm, so that the total height of the grating heights d1 and d2 can be reduced compared to the diffraction gratings in Example 4.

A minimum pitch between the unit gratings of the diffraction gratings DG1 and DG2 is 22.0 μm. A distance between the envelope 12 connecting the grating vertices of the diffraction grating DG1 and the interface 41 of the resin material layer 40 is 4.0 μm.

A distance da between the interface 41 of the resin material layer 40 and the envelope 21 connecting the grating vertices of the diffraction grating DG2 is 1.50 μm.

As in this example, a diffraction grating consisting of two material layers without an air layer in either the diffraction grating DG1 or the diffraction grating DG2 can reduce the total grating height, increases the molding stability of the diffraction grating, and suppresses the generation of unnecessary light generated by the wall surface portion 14 and the wall surface portion 24.

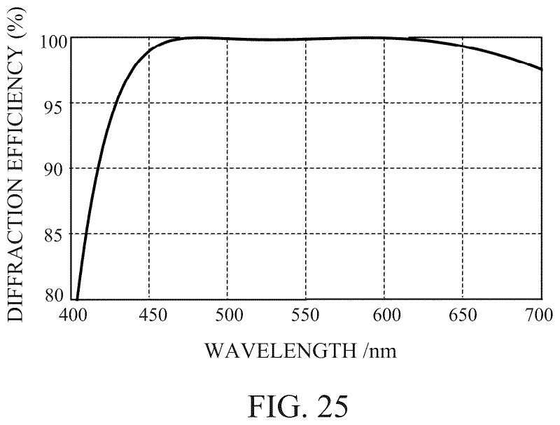

FIG. 25 illustrates the diffraction efficiency in the annulus at the central part (pitch 922 μm) of the DOE according to numerical example 8. As illustrated in FIG. 25, high diffraction efficiency is obtained over a wide range of the visible wavelength range.

Numerical examples 1 to 8 will be illustrated below. In each numerical example, surface number i indicates the order of a surface counted from the observation side. (SP) represents a pupil plane SP. r represents a radius of curvature (mm) of an i-th surface from the observation side, d represents a lens thickness or air gap (mm) on the optical axis between i-th and (i+1)-th surfaces, and nd represents a refractive index for the d-line of the optical material between i-th and (i+1)-th surfaces. vd represents an Abbe number based on the d-line of the optical material between i-th and (i+1)-th surfaces, and is defined by equation (a). As discussed, the effective diameter is a diameter of an area through which light rays contribute to imaging at each surface pass.

A focal length f (mm) is a value in an in-focus state on an object at infinity. BF represents back focus, which is the length on the optical axis from the surface closest to the display surface in the optical system to the display surface. An overall lens length is a length on the optical axis from the surface closest to the observation side (first surface) in the optical system to the display surface. EPD represents a pupil diameter (mm).

An asterisk “*” next to a surface number means that the surface has an aspherical shape. The aspherical shape is expressed by equation (e). In the conic constant and aspherical coefficient, “e±Z” means “×10^{±Z}.”

The phase shape of each diffraction surface is expressed by equation (g). The focal length fdo generated by the diffraction grating for the wavelength λ and the diffraction order m can be expressed as the following equation (j) using the lowest-order phase coefficient C2.

$$fdo ( λ , m ) = - 1 / ( 2 C 2 m λ / λ 0 ) \qquad ( j )$$

In each numerical example, the diffraction order m of each diffraction grating is 1, and the Designed Wavelength λ0 of the diffraction grating is the same as the Designed Wavelength λ of the optical system.

After numerical example 6, Table 1 summarizes values of inequalities (1) to (8). The optical system according to each numerical example satisfies all of inequalities (1) to (8).

### Numerical Example 1

UNIT: mm
SURFACE DATA

| Surface No. | r | d | nd | νd | Effective Diameter |
|---|---|---|---|---|---|
| 1 (SP) | ∞ | 17.000 | | | 6.00 |
| 2* | 444.0262 | 4.497 | 1.54400 | 56.0 | 37.13 |
| 3 (diffraction) | −82.0909 | 3.500 | 1.67100 | 19.2 | 39.12 |
| 4* | −60.3386 | 0.300 | | | 43.66 |
| 5* | −71.9328 | 6.781 | 1.54400 | 56.0 | 45.41 |
| 6* | −44.6919 | −6.781 | 1.54400 | 56.0 | 48.83 |
| 7* | −71.9328 | −0.300 | | | 48.89 |
| 8* | −60.3386 | 0.300 | | | 48.84 |
| 9* | −71.9328 | 6.781 | 1.54400 | 56.0 | 48.50 |
| 10* | −44.6919 | 9.434 | | | 47.22 |
| Image Plane | ∞ | | | | |

ASPHERIC DATA

2nd Surface
K = 0.00000e+00 A4 = −1.63018e−06 A6 = 1.44922e−08 A8 = −4.23843e−11
3rd Surface
K = 0.00000e+00 A4 = −1.57483e−06
3rd Surface (Diffraction Surface)
C 2 = −8.08446e−04 C 4 = −4.87371e−07 C 6 = 2.03970e−09
4th Surface
K = 0.00000e+00 A4 = 1.02974e−05 A6 −3.14829e−09 A8 = 2.96426e−12
5th Surface
K = 0.00000e+00 A4 = 7.86098e−06
6th Surface
K = 0.00000e+00 A4 = 2.52551e−06 A6 = 3.65413e−09 A8 = 1.19748e−12
7th Surface
K = 0.00000e+00 A4 = 7.86098e−06
8th Surface
K = 0.00000e+00 A4 = 1.02974e−05 A6 = −3.14829e−09 A8 = 2.96426e−12
9th Surface
K = 0.00000e+00 A4 = 7.86098e−06
10th Surface
K = 0.00000e+00 A4 = 2.52551e−06 A6 = 3.65413e−09 A8 = 1.19748e−12

| | |
|---|---|
| Focal Length | 21.500 |
| EPD | 6.0 |
| Half Angle of View (°) | 47.000 |
| Overall Lens Length | 55.674 |
| BF | 9.434 |

### Numerical Example 2

UNIT: mm
SURFACE DATA

| Surface No. | r | d | nd | νd | Effective Diameter |
|---|---|---|---|---|---|
| 1 (SP) | ∞ | 12.000 | | | 4.00 |
| 2* | 86.1298 | 5.000 | 1.54400 | 56.0 | 30.44 |
| 3 (diffraction) | −43.0539 | 3.000 | 1.68100 | 18.2 | 32.76 |
| 4* | −61.1284 | 0.500 | | | 37.80 |
| 5* | −59.5655 | 6.382 | 1.54400 | 56.0 | 39.95 |
| 6* | −34.9728 | −6.382 | 1.54400 | 56.0 | 43.01 |
| 7* | −59.5655 | 6.382 | 1.54400 | 56.0 | 42.77 |
| 8* | −34.9728 | 5.010 | | | 41.41 |
| Image Plane | ∞ | | | | |

ASPHERIC DATA

2nd Surface
K = 0.00000e+00 A4 = −1.12121e−05 A6 = 7.30851e−08 A8 = −3.62353e−10
3rd Surface
K = 0.00000e+00 A4 = 7.73152e−06
3rd Surface (Diffraction Surface)
C 2 = −5.36232e−04 C 4 = −2.04774e−06 C 6 = 3.81652e−09
4th Surface
K = 0.00000e+00 A4 = 6.04599e−06 A6 = 2.13242e−08 A8 = −2.35387e−11
5th Surface
K = 0.00000e+00 A4 = 1.13108e−05 A6 = 1.78099e−09
6th Surface
K = 0.00000e+00 A4 = 3.65389e−06 A6 = 8.46500e−09 A8 = 4.42130e−12
7th Surface
K = 0.00000e+00 A4 = 1.13108e−05 A6 = 1.78099e−09
8th Surface
K = 0.00000e+00 A4 = 3.65389e−06 A6 = 8.46500e−09 A8 = 4.42130e−12

| | |
|---|---|
| Focal Length | 15.475 |
| EPD | 4.00 |
| Half Angle of View (°) | 50.000 |
| Overall Lens Length | 44.657 |
| BF | 5.010 |

### Numerical Example 3

UNIT: mm
SURFACE DATA

| Surface No. | r | d | nd | νd | Effective Diameter |
|---|---|---|---|---|---|
| 1 (SP) | ∞ | 11.998 | | | 4.00 |
| 2 | 61.5379 | 4.500 | 1.49350 | 57.4 | 33.67 |
| 3 (diffraction) | 112.8060 | 3.000 | 1.68100 | 18.2 | 35.99 |
| 4 | ∞ | 0.500 | | | 39.44 |
| 5 | 238.8355 | 7.938 | 1.54400 | 56.0 | 42.57 |
| 6* | −66.7708 | −7.938 | 1.54400 | 56.0 | 45.45 |
| 7 | 238.8355 | −0.500 | | | 44.01 |
| 8 | ∞ | 0.500 | | | 42.60 |
| 9 | 238.8355 | 7.938 | 1.54400 | 56.0 | 41.30 |
| 10* | −66.7708 | 3.987 | | | 38.61 |
| Image Plane | ∞ | | | | |

ASPHERIC DATA

2nd Surface
K = 0.00000e+00 A4 = −3.97783e−06 A6 = −2.10683e−09 A8 = −3.28975e−11
3rd Surface
K = 0.00000e+00 A4 = −1.91293e−05
3rd Surface (Diffraction Surface)
C 2 = −1.46465e−03 C 4 = 1.56113e−06 C 6 = −1.02946e−09
6th Surface
K = 0.00000e+00 A4 = −5.49541e−08 A6 = −5.50767e−11 A8 = 3.12728e−13
10th Surface
K = 0.00000e+00 A4 = −5.49541e−08 A6 = −5.50767e−11 A8 = 3.12728e−13

| | |
|---|---|
| Focal Length | 16.815 |
| EPD | 4.00 |
| Half Angle of View (°) | 50.000 |
| Overall Lens Length | 48.799 |
| BF | 3.987 |

### Numerical Example 4

UNIT: mm
SURFACE DATA

| Surface No. | r | d | nd | νd | Effective Diameter |
|---|---|---|---|---|---|
| 1 (SP) | ∞ | 12.000 | | | 4.00 |
| 2* | 450.8980 | 4.920 | 1.54400 | 54.0 | 31.31 |
| 3* | −39.0645 | 0.453 | | | 33.44 |
| 4* | −78.8757 | −0.453 | | | 35.57 |
| 5* | −39.0645 | −4.920 | 1.54400 | 54.0 | 36.83 |
| 6* | 450.8980 | 4.920 | 1.54400 | 54.0 | 38.06 |
| 7* | −39.0645 | 0.453 | | | 37.25 |
| 8* | −78.8757 | 1.988 | 1.68100 | 18.2 | 36.65 |
| 9 (diffraction) | 60.2310 | 6.243 | 1.54400 | 56.0 | 35.53 |
| 10* | −77.4925 | 3.987 | | | 34.95 |
| Image Plane | ∞ | | | | |

ASPHERIC DATA

2nd Surface
K = 0.00000e+00 A4 = 3.76885e−06 A6 = 1.99451e−09 A8 = 3.14242e−11
3rd Surface
K = 0.00000e+00 A4 = 1.05898e−05 A6 = −1.40522e−09 A8 = 1.11893e−10
4th Surface
K = 0.00000e+00 A4 = 9.14291e−07 A6 = 1.16943e−08
5th Surface
K = 0.00000e+00 A4 = 1.05898e−05 A6 = −1.40522e−09 A8 = 1.11893e−10
6th Surface
K = 0.00000e+00 A4 = 3.76885e−06 A6 = 1.99451e−09 A8 = 3.14242e−11
7th Surface
K = 0.00000e+00 A4 = 1.05898e−05 A6 = −1.40522e−09 A8 = 1.11893e−10
8th Surface
K = 0.00000e+00 A4 = 9.14291e−07 A6 = 1.16943e−08
9th Surface
K = 0.00000e+00 A4 = −1.68884e−05
9th Surface (Diffraction Surface)
C 2 = −6.90599e−04 C 4 = −1.13076e−06 C 6 = 2.23600e−09
10th Surface
K = 0.00000e+00 A4 = −3.05170e−05 A6 = 3.81798e−08

| | |
|---|---|
| Focal Length | 15.623 |
| EPD | 4.00 |
| Half Angle of View (°) | 50.000 |
| Overall Lens Length | 40.337 |
| BF | 3.987 |

### Numerical Example 5

UNIT: mm
SURFACE DATA

| Surface No. | r | d | nd | νd | Effective Diameter |
|---|---|---|---|---|---|
| 1 (SP) | ∞ | 12.000 | | | 4.00 |
| 2* | 74.8986 | 5.139 | 1.54400 | 54.0 | 35.80 |
| 3* | −76.7438 | 0.442 | | | 37.36 |
| 4 | ∞ | −0.442 | | | 39.00 |
| 5* | −76.7438 | −5.139 | 1.54400 | 54.0 | 40.28 |
| 6* | 74.8986 | 5.139 | 1.54400 | 54.0 | 41.73 |
| 7* | −76.7438 | 0.442 | | | 40.61 |
| 8 | ∞ | 2.444 | 1.64100 | 22.3 | 39.82 |
| 9 (diffraction) | 53.5650 | 8.008 | 1.53000 | 55.5 | 37.02 |
| 10* | 123.7150 | 3.989 | | | 34.68 |
| Image Plane | ∞ | | | | |

ASPHERIC DATA

2nd Surface
K = 0.00000e+00 A4 = 5.67079e−06 A6 = −1.09139e−08 A8 = 2.08067e−11
3rd Surface
K = 0.00000e+00 A4 = 1.79262e−05 A6 = −3.22196e−08 A8 = 6.53950e−11
5th Surface
K = 0.00000e+00 A4 = 1.79262e−05 A6 = −3.22196e−08 A8 = 6.53950e−11
6th Surface
K = 0.00000e+00 A4 = 5.67079e−06 A6 = −1.09139e−08 A8 = 2.08067e−11
7th Surface
K = 0.00000e+00 A4 = 1.79262e−05 A6 = −3.22196e−08 A8 = 6.53950e−11
9th Surface
K = 0.00000e+00 A4 = −4.07176e−06
9th Surface (Diffraction Surface)
C 2 = −1.45476e−03 C 4 = 1.13133e−06 C 6 = 5.37718e−10
10th Surface
K = 0.00000e+00 A4 = −4.76831e−05 A6 = 4.99682e−08

| | |
|---|---|
| Focal Length | 16.069 |
| EPD | 4.00 |
| Half Angle of View (°) | 50.000 |
| Overall Lens Length | 43.185 |
| BF | 3.989 |

### Numerical Example 6

UNIT: mm
SURFACE DATA

| Surface No. | r | d | nd | νd | Effective Diameter |
|---|---|---|---|---|---|
| 1 (SP) | ∞ | 12.000 | | | 4.00 |
| 2* | 89.0086 | 5.000 | 1.54400 | 56.0 | 30.12 |
| 3 (diffraction) | −36.1351 | 3.000 | 1.68100 | 18.2 | 32.38 |
| 4* | −45.4384 | 0.500 | | | 36.40 |
| 5* | −44.9519 | 5.156 | 1.54400 | 56.0 | 38.40 |
| 6* | −30.3984 | −5.156 | 1.54400 | 56.0 | 40.48 |
| 7* | −44.9519 | 5.156 | 1.54400 | 56.0 | 39.85 |
| 8* | −30.3984 | 0.100 | | | 39.05 |
| 9* | −37.5728 | 2.000 | 1.68100 | 18.2 | 36.08 |
| 10* | −52.0412 | 5.007 | | | 35.09 |
| Image Plane | ∞ | | | | |

ASPHERIC DATA

2nd Surface
K = 0.00000e+00 A4 = −1.24508e−05 A6 = 6.62620e−08 A8 = −3.15670e−10
3rd Surface
K = 0.00000e+00 A4 = 1.61455e−05
3rd Surface (Diffraction Surface)
C 2 = −3.33417e−04 C 4 = −2.99473e−06 C 6 = 6.45085e−09
4th Surface
K = 0.00000e+00 A4 = 6.61676e−06 A6 = 9.33064e−09 A8 = 2.91436e−11
5th Surface
K = 0.00000e+00 A4 = 1.33910e−05 A6 = 3.96348e−09
6th Surface
K = 0.00000e+00 A4 = 4.78494e−06 A6 = 1.20650e−08 A8 = 5.03536e−12
7th Surface
K = 0.00000e+00 A4 = 1.33910e−05 A6 = 3.96348e−09
8th Surface
K = 0.00000e+00 A4 = 4.78494e−06 A6 = 1.20650e−08 A8 = 5.03536e−12
9th Surface
K = 0.00000e+00 A4 = 4.88072e−06
10th Surface
K = 0.00000e+00 A4 = −7.80829e−07

| | |
|---|---|
| Focal Length | 15.439 |
| EPD | 4.00 |
| Half Angle of View (°) | 50.000 |
| Overall Lens Length | 43.076 |
| BF | 5.007 |

TABLE 1

| | Numerical Example | | | | | | |
|---|---|---|---|---|---|---|---|
| Inequality | 1 | 2 | 3 | 4 | 5 | 6 | 8 |
| R11 | 907.66 | 187.47 | 81.04 | −104.95 | ∞ | 195.60 | −104.95 |
| R12 | −75.02 | −51.38 | −288.72 | 158.71 | 62.12 | −49.53 | 158.71 |
| R21 | −75.02 | −51.38 | −288.72 | 158.71 | 62.12 | −49.53 | 158.71 |
| R22 | −167.17 | −110.06 | ∞ | −42.54 | −87.70 | −70.54 | −42.54 |
| f1e | 127.6 | 74.7 | 128.7 | −92.5 | −96.9 | 73.2 | −92.5 |
| f2e | −206.0 | −144.5 | −424.0 | 62.4 | 69.9 | −259.2 | 62.4 |
| PD1 | Positive | Positive | Positive | Negative | Negative | Positive | Negative |
| PD2 | Negative | Negative | Negative | Positive | Positive | Negative | Positive |
| (1) | 0.345 | 0.537 | 0.258 | 0.710 | 0.742 | 0.464 | 0.710 |
| ν1 | 56.0 | 56.0 | 57.4 | 18.2 | 22.3 | 56.0 | 18.2 |
| ν2 | 19.2 | 18.2 | 18.2 | 56.0 | 55.5 | 18.2 | 56.0 |
| (2)νH | 56.0 | 56.0 | 57.4 | 56.0 | 55.5 | 56.0 | 56.0 |
| (3)νL | 19.2 | 18.2 | 18.2 | 18.2 | 22.3 | 18.2 | 18.2 |
| (4) | 0.0342 | 0.0371 | 0.0375 | 0.0371 | 0.0268 | 0.0371 | 0.0371 |
| (5)dH | 8.00 | 7.50 | 7.50 | 7.80 | 8.70 | 7.50 | 2.80 |
| (5)dL | 5.62 | 5.14 | 4.58 | 5.37 | 6.29 | 5.14 | 5.98 |
| NH | 1.544 | 1.544 | 1.494 | 1.544 | 1.530 | 1.544 | 1.544 |
| NL | 1.671 | 1.681 | 1.681 | 1.681 | 1.641 | 1.681 | 1.681 |
| ΔNH | 0.544 | 0.544 | 0.494 | 0.544 | 0.530 | 0.544 | 0.544 |
| ΔNL | 0.671 | 0.681 | 0.681 | 0.681 | 0.641 | 0.681 | 0.157 |
| (6) | 1.15 | 1.17 | 1.19 | 1.16 | 1.14 | 1.17 | 1.63 |
| Pdo | 0.00162 | 0.00107 | 0.00112 | 0.00138 | 0.00291 | 0.00067 | 0.00138 |
| (6-1) | 0.58 | 0.58 | 0.58 | 0.58 | 0.58 | 0.58 | 0.59 |
| (7) | 7.9 | 18.9 | 9.0 | 19.4 | 8.5 | 26.3 | 19.4 |
| Pmin | 27.3 | 22.0 | 21.0 | 22.0 | 22.0 | 27.4 | 22.0 |
| (8) | 2.00 | 1.74 | 1.74 | 1.67 | 1.47 | 2.17 | 2.51 |

### Display Apparatus

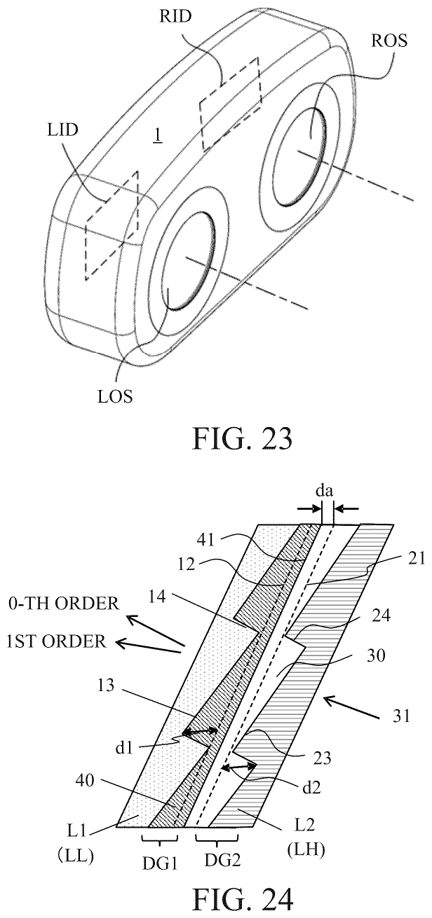

FIG. 23 illustrates a head-mounted display (HMD) as a display apparatus using the optical system according to any one of Examples 1 to 8. The HMD is attached to the head (in front of the eyes) of the observer by an attachment gear (not illustrated).

The HMD includes right-eye and left-eye display elements RID and LID, a right-eye optical system ROS configured to guide display light from the right-eye display element RID to the observer's right eye, and a left-eye optical system LOS configured to guide display light from the left-eye display element LID to the observer's left eye.

Using the optical system according to any one of Examples 1 to 8 as the right-eye and left-eye optical systems ROS and LOS, the HMD enables bright images to be observed over the entire field of view. Part of the distortion and lateral chromatic aberration may be reduced by electrical correction processing of the original image displayed on the display element.

While the disclosure has described example embodiments, it is to be understood that the disclosure is not limited to the example embodiments. The scope of the following claims is to be accorded the broadest interpretation so as to encompass all such modifications and equivalent structures and functions.

Each example can provide an optical system that has a diffraction surface and can display a good image.

This application claims priority to Japanese Patent Application No. 2024-101238, which was filed on Jun. 24, 2024, and which is hereby incorporated by reference herein in its entirety.

What is claimed is:

1. An optical system configured to guide light from a display surface to an observation side, the optical system comprising:
a first lens;
a second lens disposed on a display surface side relative to the first lens; and
a third lens with positive refractive power disposed on the observation side relative to the first lens or on the display surface side relative to the second lens,
wherein a surface of the first lens disposed on the display surface side of the first lens includes a first diffraction surface,
wherein a surface of the second lens disposed on the observation side of the second lens includes a second diffraction surface,
wherein the first diffraction surface and the second diffraction surface are adjacent to each other, and
wherein the optical system further comprises a first transmissive reflective surface and a second transmissive reflective surface disposed at positions different from the surface of the first lens disposed on the display surface side of the first lens and the surface of the second lens disposed on the observation side of the second lens.

2. The optical system according to claim 1, wherein the surface of the first lens disposed on the display surface side of the first lens which includes the first diffraction surface and the surface of the second lens disposed on the observation side of the second lens which includes the second diffraction surface are curved surfaces.

3. The optical system according to claim 1, wherein both the first transmissive reflective surface and the second transmissive reflective surface are disposed on the observation side or the display surface side relative to each of the first diffraction surface and the second diffraction surface.

4. The optical system according to claim 1, wherein at least one of the first transmissive reflective surface and the second transmissive reflective surface is flat.

5. The optical system according to claim 1, wherein a sign of a focal length f1e of the first lens calculated from a radius of curvature R11 in an effective area on a surface of the first lens disposed on the observation side of the first lens and a radius of curvature R12 in an effective area on the surface of the first lens disposed on the display surface side of the first lens is equal to a sign of diffraction power generated on the first diffraction surface.

6. The optical system according to claim 1, wherein a sign of a focal length f2e of the second lens calculated from a radius of curvature R21 in an effective area on the surface of the second lens disposed on the observation side of the second lens and a radius of curvature R22 in the effective area on a surface of the second lens disposed on the display surface side of the second lens is equal to a sign of diffraction power generated on the second diffraction surface.

7. The optical system according to claim 1, further comprising a layer provided between the first diffraction surface and the second diffraction surface, and having a refractive index for an incident wavelength lower than a refractive index of each of the first lens and the second lens for the incident wavelength.

8. The optical system according to claim 1, wherein the following inequality is satisfied:
$$0 < 1000 \times ( 1 / f 1 e - 1 / f 2 e ) / ( v 1 - v 2 )$$
where f1e (mm) is a focal length of the first lens calculated from a radius of curvature R11 in an effective area on the surface of the first lens disposed on the observation side of the first lens and a radius of curvature R12 in an effective area on a surface of the first lens disposed on the display surface side of the first lens, f2e (mm) is a focal length of the second lens calculated from a radius of curvature R21 in an effective area on the surface of the second lens disposed on the observation side of the second lens and a radius of curvature R22 in an effective area on a surface of the second lens disposed on the display surface side of the second lens, v1 is an Abbe number based on an incident wavelength of a diffraction grating on the first diffraction surface, and v2 is an Abbe number based the incident wavelength of a diffraction grating on the second diffraction surface.

9. The optical system according to claim 1, wherein the following inequality is satisfied:
$$35 \leq vH \leq 70$$
where vH is an Abbe number based on an incident wavelength of a diffraction grating on one of the first diffraction surface and the second diffraction surface formed on the first lens and the second lens, which has a larger Abbe number based on the incident wavelength.

10. The optical system according to claim 1, wherein the following inequality is satisfied:
$$10 \leq vL \leq 50$$
where vL is an Abbe number based on an incident wavelength of a diffraction grating on one of the first diffraction surface and the second diffraction surface formed on the first lens and the second lens, which has a smaller Abbe number based on the incident wavelength.

11. The optical system according to claim 1, wherein the following inequality is satisfied:
$$0.01 \leq \vert 1 / vH - 1 / vL \vert \leq 0. 060$$
where vH is an Abbe number based on an incident wavelength of a diffraction grating on one of the first diffraction surface and the second diffraction surface formed on the first lens and the second lens, which has a larger Abbe number based on the incident wavelength, and vL is an Abbe number based on the incident wavelength of a diffraction grating on another of the first diffraction surface and the second diffraction surface, which has a smaller Abbe number.

12. The optical system according to claim 1, wherein the following inequality is satisfied:
$$dL < dH$$
where dH (μm) is a grating height of a diffraction grating on one of the first diffraction surface and the second diffraction surface formed on the first lens and the second lens, which has a larger Abbe number based on an incident wavelength, and dL (μm) is a grating height of a diffraction grating on another of the first diffraction surface and the second diffraction surface, which has a smaller Abbe number.

13. The optical system according to claim 1, wherein the following inequality is satisfied:
$$0.6 \leq ( Δ NH \times dH ) / ( Δ NL \times dL ) \leq 1.7$$
where ΔNH is a refractive index difference at an incident wavelength between a diffraction grating on one of the first diffraction surface and the second diffraction surface formed on the first lens and the second lens, which has a larger Abbe number based on the incident wavelength and a material layer that contacts the diffraction grating via the diffraction surface, and ΔNL is a refractive index difference at the incident wavelength between a diffraction grating on another of the first diffraction surface and the second diffraction surface, which has a smaller Abbe number and the material layer that contacts the diffraction grating through the diffraction surface.

14. The optical system according to claim 13, wherein the following inequality is satisfied:
$$0. 45 \leq Δ NH \times dH - Δ NL \times dL \leq 0.75 .$$

15. The optical system according to claim 1, wherein the following inequality is satisfied:
$$4. \leq \vert ( 1 / f 1 e - 1 / f 2 e ) / Pdo \vert \leq 40.0$$
where f1e (mm) is a focal length of the first lens calculated from a radius of curvature R11 in an effective area on a surface of the first lens disposed on the observation side of the first lens and a radius of curvature R12 in an effective area on the surface of the first lens disposed on the display surface side of the first lens, f2e (mm) is a focal length of the second lens calculated from a radius of curvature R21 in an effective area on the surface of the second lens disposed on the observation side of the second lens and a radius of curvature R22 in an effective area on a surface of the second lens disposed on the display surface side of the second lens, and Pdo is diffraction power generated on each of the first diffraction surface and the second diffraction surface.

16. The optical system according to claim 1, wherein the following inequality is satisfied:
$$0.8 \leq P min / ( dH + dL ) \leq 4.0$$
where dH is a grating height of a diffraction grating on the first diffraction surface, dL is a grating height of a diffraction grating on the second diffraction surface, and Pmin is a minimum pitch in the diffraction grating of the first lens and the diffraction grating of the second lens.

17. The optical system according to claim 1, wherein only one of the first transmissive reflective surface and the second transmissive reflective surface includes a transmissive reflective element having polarization selectivity.

18. The optical system according to claim 1, wherein the first transmissive reflective surface and the second transmissive reflective surface are provided on one of the first lens, the second lens, and the third lens.

19. The optical system according to claim 18, wherein the first transmissive reflective surface and the second transmissive reflective surface are provided on the second lens and the third lens.

20. A display apparatus comprising:
a display element having a display surface; and
an optical system configured to guide light from the display surface to an observation side,
wherein the optical system includes:
a first lens,
a second lens disposed on a display surface side relative to the first lens, and
a third lens with positive refractive power disposed on the observation side relative to the first lens or on the display surface side relative to the second lens,
wherein a surface of the first lens disposed on the display surface side of the first lens includes a first diffraction surface,
wherein a surface of the second lens disposed on the observation side of the second lens includes a second diffraction surface,
wherein the first diffraction surface and the second diffraction surface are adjacent to each other, and
wherein the optical system further comprises a first transmissive reflective surface and a second transmissive reflective surface disposed at positions different from the surface of the first lens disposed on the display surface side of the first lens and the surface of the second lens disposed on the observation side of the second lens.
